(19) United States
(12) Patent Application Publication
(10) Pub. No.: US 2012/0054793 A1
(43) Pub. Date: Mar. 1, 2012

(54) METHOD FOR SYNCHRONIZING CONTENTS AND DISPLAY DEVICE ENABLING THE METHOD

(76) Inventors: Haeng Joon KANG, Pyeongtaek-si (KR); Myong Won Suh, Pyeongtaek-si (KR)

(21) Appl. No.: 13/025,800

(22) Filed: Feb. 11, 2011

Related U.S. Application Data
(60) Provisional application No. 61/379,352, filed on Sep. 1, 2010.

(30) Foreign Application Priority Data
Aug. 24, 2010 (KR) 10-2010-0081903

(51) Int. Cl. H04N 5/445; H04N 7/173

(52) U.S. Cl. 725/38; 725/110

(57) ABSTRACT

A method for synchronizing information stored in different display devices includes selecting first content in a first display device, selecting a second display device to be synchronized, and then sending a list of the first content from the first display device to a server. In the server, a list of second content of the second display device is compared with the list of first content, and the first content is transmitted from the first display device to the server when the first content is not in the list of second content. The first content is then transmitted from the server to the second display device.

### CROSS-REFERENCE TO RELATED APPLICATIONS

This application claims the benefit of the Korean Patent Application No. P2010-81903, filed on Aug. 24, 2010, and is also based on and claims priority to U.S. provisional application No. 61/379,352, filed on Sep. 1, 2010. The contents of these applications are incorporated herein by reference.

### BACKGROUND

1. Field

One or more embodiments described herein relate to managing information in one or more electronic devices.

2. Background

Various types of electronic devices capable of storing and reproducing multimedia and other types of information are now offered on the market. These devices include televisions, phones, music players, and many more. Most users own a plurality of these devices and would like to transfer multimedia, text, and/or application program information between or among these devices and/or one or more servers in an easy and efficient way.

### BRIEF DESCRIPTION OF THE DRAWINGS

FIG. 1 shows an example of a broadcasting system.

FIG. 2 shows another example of a broadcasting system.

FIG. 3 shows a process for receiving channel information in a display device included in the systems of FIG. 1 or 2 by accessing a service provider.

FIG. 4 shows an example of data used in the aforementioned process.

FIG. 5 shows an example of a display device that may be included in one or more of the aforementioned systems.

FIG. 6 shows another example of a display device.

FIGS. 7 and 8 show a set-top box and a disc player.

FIG. 9 shows a communication procedure used between display devices.

FIG. 10 shows a control module as in FIG. 6.

FIG. 11 shows an example of a platform structure of a display device.

FIG. 12 shows another example of a platform structure.

FIG. 13 shows one embodiment of a method for controlling a remote controller for controlling a display device.

FIG. 14 shows an example of the remote controller.

FIG. 15 shows a first example of a user interface of a display device.

FIG. 16 shows a second example of a user interface.

FIG. 17 shows a third example of a user interface.

FIG. 18 shows a fourth example of a user interface.

FIG. 19 shows one embodiment of a content synchronizing system.

FIG. 20 shows one embodiment of a content synchronizing method.

FIG. 21 shows another embodiment of a content synchronizing method.

FIG. 22 shows process steps for displaying a list of received content.

FIG. 23 shows another embodiment of a content synchronizing method.

FIG. 24 shows one type of user interface that includes a menu list for implementing content synchronization.

FIG. 25 shows a user interface that includes a selection menu for use in content synchronization.

FIG. 26 shows another user interface that includes a selection menu for use in content synchronization.

FIG. 27 shows another user interface that includes a selection menu for use in content synchronization.

FIG. 28 shows a user interface that displays a content synchronization notification message.

FIG. 29 shows is a user interface that displays a list of contents for synchronization.

FIG. 30 shows a user interface that displays a content search menu to be used in synchronization.

FIG. 31 shows a user interface that displays detailed information screen for content to be synchronized.

FIG. 32 shows a user interface that displays a selection menu for use in content synchronization.

### DETAILED DESCRIPTION

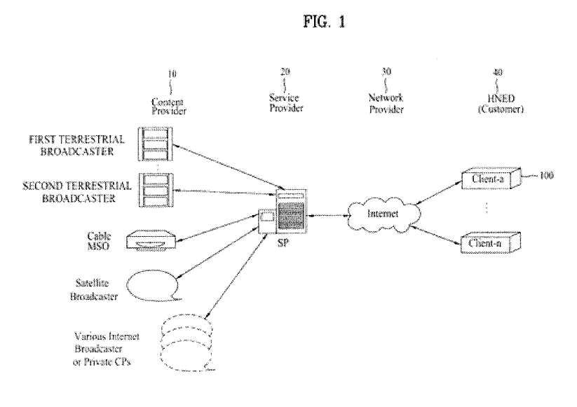

FIG. 1 shows an example of a broadcasting system including a display device which includes a display device according to one embodiment of the present invention includes a content provider (CP) 10, a service provider (SP) 20, a network provider (NP) 30, and a home network end user (HNED) 40. The HNED 40 corresponds to, for example, a client 100 which is a display device according to the embodiment of the present invention. The client 100 corresponds to the display device according to one embodiment of the present invention, wherein examples of the display device include network TV, smart TV, and IPTV.

The content provider 10 manufactures various contents and provides them. Examples of the content provider 10 include a terrestrial broadcaster, a cable system operator (SO), a multiple system operator (MSO), a satellite broadcaster, and an Internet broadcaster, as illustrated in FIG. 1.

Also, the content provider 10 may provide various applications in addition to broadcast contents, which will be described in more detail later.

The service provider 20 can provide contents provided by the content provider 10 by service packaging them. For example, the service provider 20 of FIG. 1 can package first terrestrial broadcasting, second terrestrial broadcasting, cable MSO, satellite broadcasting, various kinds of Internet broadcasting, application, etc. and provide the packaged one to a user.

In the mean time, the service provider 20 may provide a service to the client 100 by using a unicast or multicast mode. The unicast mode is to transmit data between a single transmitter and a single receiver 1:1. In case of the unicast mode, for example, if the receiver requests a server to transmit data, the server can transmit data to the receiver in accordance with the request. The multicast mode is to transmit data to a plurality of receivers of a specific group. For example, the server can transmit data to a plurality of receivers, which are previously registered therewith, at one time. For this multicast registration, IGMP (Internet Group Management Protocol) can be used.

The network provider 30 may provide a network for providing a service to the client 100. The client 100 may construct a home network end user (HNED) to receive a service.

In the system of the aforementioned display device, conditional access or content protection can be used to protect contents which are transmitted. For conditional access or content protection, a cable card or downloadable conditional access system (DCAS) can be used.

In the mean time, the client 100 may provide contents through the network. In this case, the client 100 may be a content provider contrary to the above. The content provider 10 may receive contents from the client 100. In this case, it is advantageous in that bidirectional content service or data service is available.

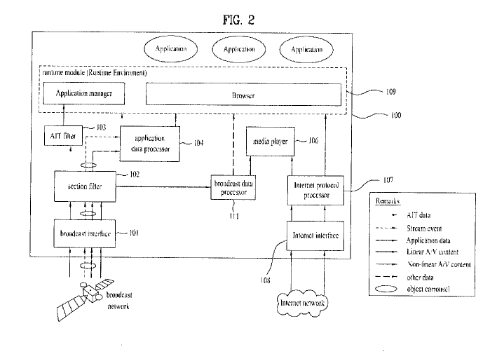

FIG. 2 shows another example of a broadcasting system including a display device 100 to be connected with a broadcast network or Internet network. Examples of the display device 100 include network TV, smart TV, and HBBTV. The display device 100 includes a broadcast interface 101, a section filter 102, an AIT filter 103, an application data processor 104, a broadcast data processor 111, a media player 106, an Internet protocol processor 107, an Internet interface 108, and a runtime module 109, for example.

Application information table (AIT) data, a real-time broadcast content, application data, and stream event are received through the broadcast interface 101. In the mean time, the real-time broadcast content may be designated as a linear A/V content.

The section filter 102 performs section filtering for four kinds of data received through the broadcast interface 101. Then, the section filter 102 transmits AIT data to the AIT filter 103, the linear A/V content to the broadcast data processor 111, and stream event and application data to the application data processor 104.

In the mean time, a non-linear A/V content and application data are received through the Internet interface 108. The non-linear A/V content may be content on demand (COD) application, for example.

The non-linear A/V content is transmitted to the media player 106, and the application data is transmitted to the runtime module 109.

Moreover, the runtime module 109, as illustrated in FIG. 2, includes an application manager and a browser, for example. The application manager controls a lifecycle for an interactive application by using the AIT data. The browser serves to display and process the interactive application.

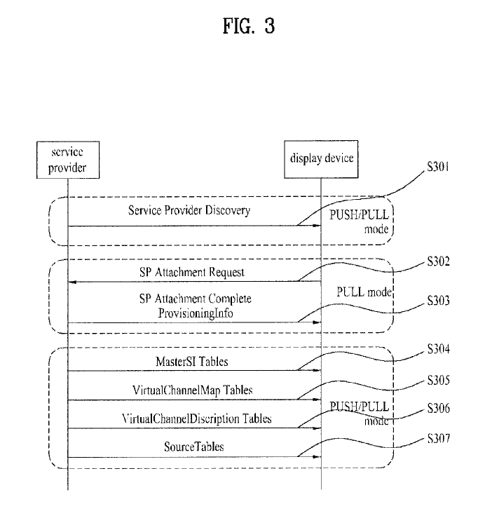

FIG. 3 is a diagram illustrating process steps for receiving channel information in a display device illustrated in FIG. 1 or FIG. 2 by accessing a service provider. It is to be understood that the method of FIG. 3 is only exemplary and the scope of the present invention is not limited by only the method of FIG. 3.

The service provider performs service provider discovery (S301). The display device transmits a service provider (SP) attachment request signal (S302). If SP attachment is finished, the display device receives provisioning information (S303). Moreover, the display device receives a master SI table from the service provider (S304), receives a virtual channel map table (S305), receives a virtual channel description table (S306), and receives a source table (S307). Hereinafter, the process steps for receiving channel information will be described in more detail.

The service provider discovery may mean that service providers, which provide IPTV related services, discover a service discovery (SD) server that provides information on the service providers.

For example, three methods for discovering an address list that can receive information (for example, SP discovery information) on the SD server will be provided as follows. First of all, an address previously set by the display device or an address set by a manual operation of the user can be used. Second, a DHCP based SP discovery method can be used. Third, a DNS SRV-based SP discovery method can be used. Also, the display device accesses a server of an address acquired by any one of the above three methods and receives a service provider discovery record that includes information required for service discovery per SP. Then, the display device performs a service search step by using the received service provider discovery record. The above steps can be performed in a push mode or pull mode.

The display device performs a registration procedure (or service attachment procedure) by accessing the SP attachment server designated by an SP attachment locator of the SP discovery record.

Moreover, after performing a separate authentication procedure by accessing an SP authentication service server designated by an SP authentication locator, the display device may perform a service authentication procedure.

In the mean time, after the service attachment procedure is successfully performed, data transmitted from the server to the display device may be a form of a provisioning information table.

The display device transmits the data to the service attachment server during the service attachment procedure, wherein the data includes ID and location information of the display device. The service attachment server can define a service subscribed by the display device, based on the received data. Moreover, address information that can acquire service information desired to be received by the display device is provided in the form of the provisioning information table. The address information corresponds to access information of the master SI table. In this case, it is easy to provide a customized service per subscriber.

The service information includes a master SI table record that manages access information and version on the virtual channel map, a virtual channel map table that provides a package type service list, a virtual channel description table that includes detailed information of each channel, and a source table that includes access information that enables actual access to services.

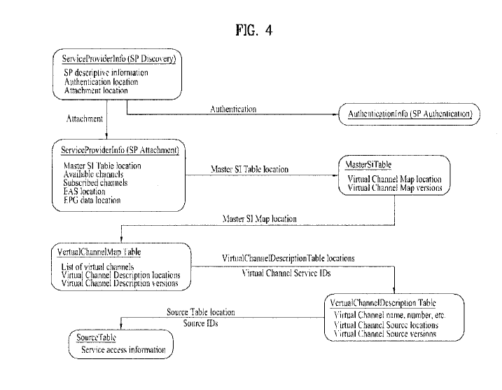

FIG. 4 is a diagram illustrating an example of data used in the steps shown in FIG. 3. Hereinafter, the relation between data within SI will be described with reference to FIG. 4. The mater SI table includes location information that can receive each virtual channel map and version information of each virtual channel map.

Each virtual channel map is uniquely identified by a virtual channel map identifier, and virtual channel map version represents version information of the virtual channel map. If any one of all tables connected to one another along an arrow starting from the master SI table illustrated in FIG. 4 is changed, version of all upper tables (to reach master SI table) is increased together with increase of the corresponding table. Accordingly, it is advantageous in that the display device can identify change on all SI tables directly by monitoring the master SI table.

For example, if there is any change of the source table, version of the source table is increased, and version of the virtual channel description table for reference of the source table is also changed. Accordingly, change of a lower table causes change of an upper table, whereby version of the master SI table is finally changed.

The master SI table may exist per service provider. However, if configuration of the service is varied per location or subscriber (or subscriber group), the service provider is designed to have a plurality of master SI tables, thereby providing a customized service per each unit. In this way, if the service provider is designed, it is possible to efficiently provide a customized service for location of a subscriber and subscription information through the master SI table.

The virtual channel map table may have one or more virtual channels, and includes location information that can acquire detailed information of the channel without including the detailed information in the virtual channel map. Virtual channel description location of the virtual channel map table indicates location of the virtual channel description table that includes detailed information of the channel.

The virtual channel description table includes detailed information of the virtual channel, and can access the virtual channel description table by using the virtual channel description location of the virtual channel map table.

The source table provides access information (for example, IP address, port, AV codec, transport protocol, etc.) per service, wherein the access information is required for actual access to the service.

The aforementioned master SI table, the virtual channel map table, the virtual channel description table, and the source table are transferred through four flows, which are logically divided from one another, in a push mode or pull mode. In the mean time, the master SI table can be transmitted in a multicast mode for version management, and monitors version change by receiving multicast streaming.

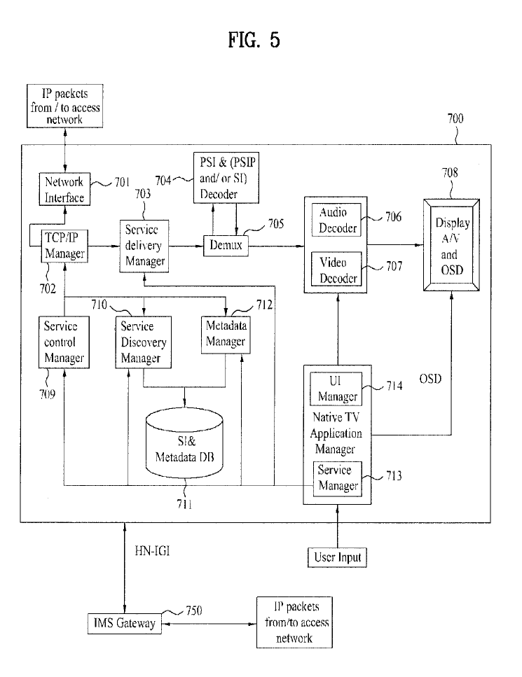

FIG. 5 is a diagram illustrating a detailed example of a display device illustrated in FIG. 1 to FIG. 2. It is to be understood that the example illustrated in FIG. 5 is only exemplary and the scope of the present invention should basically be determined by claims not the example of FIG. 5.

The display device 700 includes a network interface 701, a TCP/IP manager 702, a service delivery manager 703, a demultiplexer (Demux) 705, a PSI& (PSIP and/or SI) decoder 704, an audio decoder 706, a video decoder 707, a display A/V and OSD module 708, a service control manager 709, a service discovery manager 710, a metadata manager 712, an SI&Metadata DB 711, a UI manager 714, and a service manager 713.

The network interface 701 receives packets from a network, and transmits the packets to the network. In other words, the network interface 701 receives services, contents, etc. from the service provider through the network.

The TCP/IP manager 702 is involved in packets received in the display device 700 and packets transmitted from the display device 700, i.e., packet transfer from the source to the destination. The TCP/IP manager 702 sorts the received packets to correspond to a proper protocol, and outputs the sorted packets to the service delivery manager 705, the service discovery manager 710, the service control manager 709, and the metadata manager 712.

The service delivery manager 703 takes the role of control of received service data. For example, if the service delivery manager 703 controls real-time streaming data, it can use RTP/RTCP. If the service delivery manager 703 transmits the real-time streaming data by using RTP, it parses the received packets in accordance with RTP and transmits the parsed packets to the demultiplexer 705 or stores the parsed packets in the SI&Metadata DB 711 under the control of the service manager 713. The service delivery manager 703 feeds the received information back to a server, which provides a service, by using RTCP.

The demultiplexer 705 demultiplexes the received packets to audio, video and PSI (Program Specific Information) data and then transmits the demultiplexed data to the audio decoder 706, the video decoder 707, and the PSI&(PSIP and/or SI) decoder 704, respectively.

The PSI&(PSIP and/or SI) decoder 704 decodes service information such as PSI, for example. Namely, the PSI&(PSIP and/or SI) decoder 704 receives and decodes PSI section, PSIP (Program and Service Information Protocol) section or SI (Service Information) section, which is demultiplexed by the demultiplexer 705.

Also, the PSI&(PSIP and/or SI) decoder 704 decodes the received sections to make a database for service information, and stores the database for service information in the SI&Metadata DB 711.

The audio/video decoders 706/707 decode the video data and the audio data, which are received from the demultiplexer 705. The audio data decoded by the audio decoder 706 and the video data decoded by the video decoder 707 are provided to the user through the display 708.

The UI manager 714 and the service manager 713 manage the whole state of the display device 700, provide a user interface, and manage other managers.

The UI manager 714 provides a graphic user interface for the user by using an on screen display (OSD), and performs a receiving operation based on a key input from the user. For example, if a key input signal for channel selection is input from the user, the UI manager 714 transmits the key input signal to the service manager 713.

The service manager 713 controls managers related to the service, such as the service delivery manager 703, the service discovery manager 710, the service control manager 709, and the metadata manager 712.

Also, the service manager 713 makes a channel map and selects a channel by using the channel map in accordance with the key input signal received from the UI manager 714. The service manager 713 receives service information of the channel from the PSI&(PSIP and/or SI) decoder 704 and sets audio/video PID (Packet Identifier) of the selected channel in the demultiplexer 705.

The service discovery manager 710 provides information required to select the service provider that provides services. If a signal related to channel selection is received from the service manager 713, the service discovery manager 710 discovers a corresponding service by using the received information.

The service control manager 709 takes the role of selection and control of the service. For example, if the user selects a live broadcasting service like the existing broadcasting mode, the service control manager 709 uses IGMP or RTSP. If the user selects a video on demand (VOD) service, the service control manager 709 selects and controls the service by using RTSP. The RTSP protocol can provide a trick mode for real-time streaming. Also, the service control manager 709 can initiate and manage a session through IMC gate by using IMS (IP Multimedia Subsystem) and Session Initiation Protocol (SIP). The above protocols are only exemplary, and other protocols may be used depending on embodiments.

The metadata manager 712 manages metadata related to the service and stores the metadata in the SI&Metadata DB 711.

The SI&Metadata DB 711 stores the service information decoded by the PSI&(PSIP and/or SI) decoder 704, the metadata managed by the metadata manager 712, and the information required to select the service provider provided by the service discovery manager 710. Also, the SI&Metadata DB 711 may store setup data for the system.

The SI&Metadata DB 711 may be implemented by using a NonVolatile RAM (NVRAM) or a flash memory.

In the mean time, the IG 750 is a gateway where functions required for access to IMS based IPTV services are gathered.

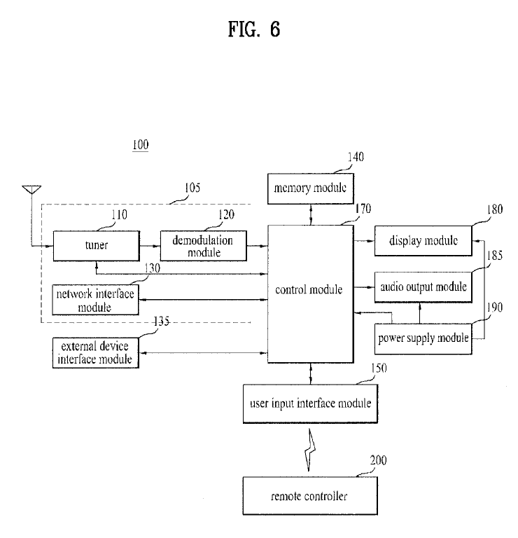

FIG. 6 is a diagram illustrating another detailed example of a display device 100 which includes a broadcast receiver 105, an external device interface module 135, a memory module 140, a user input interface module 150, a control module 170, a display module 180, an audio output module 185, a power supply module 190, and a camera module (not shown). The broadcast receiver 105 includes a tuner 110, a demodulation module 120, and a network interface module 130. As occasion demands, the broadcast receiver 105 may be designed in such a manner that it includes a tuner 110 and a demodulation module 120 but does not include a network interface module 130. On the contrary, the broadcast receiver 105 may be designed in such a manner that it includes a network interface module 130 but does not include a tuner 110 and a demodulation module 120.

The tuner 110 selects one of RF (radio frequency) broadcast signals received through an antenna, which corresponds to a channel selected by the user or all previously stored channels. Also, the tuner 110 converts the selected RF broadcast signal to an intermediate frequency signal or a baseband video or audio signal.

For example, if the selected RF broadcast signal is a digital broadcast signal, the tuner 110 coverts the selected RF broadcast signal to a digital IF (DIF) signal. If the selected RF broadcast signal is an analog broadcast signal, the tuner 110 coverts the selected RF broadcast signal to an analog baseband video or audio signal (CVBS/SIF). In other words, the tuner 110 can process both the digital broadcast signal and the analog broadcast signal. The analog baseband video or audio signal (CVBS/SIF) output from the tuner 110 may directly be input to the control module 170.

Also, the tuner 110 can receive RF broadcast signal of a single carrier based on an advanced television system committee (ATSC) mode and RF broadcast signal of multiple carriers based on a digital video broadcasting mode (DVB).

In the mean time, the tuner 110 sequentially selects RF broadcast signals of all broadcast channels stored through a channel memory function from RF broadcast signals received through the antenna, and converts the selected RF broadcast signals to intermediate frequency signals or baseband video or audio signals.

The demodulation module 120 receives the digital IF (DIF) signal converted by the tuner 110 and demodulates the received digital IF signal.

For example, if the digital IF signal output from the tuner 110 is based on the ATSC mode, the demodulation module 120 performs 8-vestigal side band (8-VSB) demodulation, for example. Also, the demodulation module 120 may perform channel decoding. To this end, the demodulation module 120 may include a trellis decoder, a de-interleaver, and a Reed-Solomon decoder to perform trellis decoding, de-interleaving, and Reed-Solomon decoding.

For example, if the digital IF signal output from the tuner 110 is based on the DVB mode, the demodulation module 120 performs coded orthogonal frequency division modulation (COFDMA) demodulation, for example. Also, the demodulation module 120 may perform channel decoding. To this end, the demodulation module 120 may include a convolution decoder, a de-interleaver, and a Reed-Solomon decoder to perform convolution decoding, de-interleaving, and Reed-Solomon decoding.

The demodulation module 120 can output a stream signal (TS) after performing demodulation and channel decoding. At this time, the stream signal may be a signal where a video signal, an audio signal and a data signal are multiplexed. For example, the stream signal may be MPEG-2 Transport Stream (TS) where a video signal of an MPEG-2 specification and an audio signal of Dolby AC-3 specification are multiplexed. Specifically, the MPEG-2 TS may include a 4 byte header and 184 byte payload.

In the mean time, the aforementioned demodulation module 120 may be provided separately depending on the ATSC mode and the DVB mode. Namely, an ATSC demodulation module and a DVB demodulation module may be provided separately.

The stream signal output from the demodulation module 120 may be input to the control module 170. The control module 170 performs demultiplexing, video/audio signal processing, etc. and then outputs video to the display module 180 and audio to the audio output module 185.

The external device interface module 135 may connect an external device to the display device 100. To this end, the external device interface module 135 may include an A/V input/output unit (not shown) or a wireless communication unit (not shown).

The external device interface module 135 is connected to external devices such as Digital Versatile Disks (DVD), Blu-rays, game devices, cameras, camcorders, computers (e.g., notebook computers), etc. through wire/wireless cables. The external device interface module 135 transmits a video, audio, or data signal externally input through an external device connected thereto, to the control module 170 of the display device 100. Also, the external device interface module 135 outputs the video, audio or data signal processed by the control module 170 to the external device. To this end, the external device interface module 135 may include an A/V input/output unit (not shown) or a wireless communication unit (not shown).

The A/V input/output unit of the external input circuit may include a USB terminal, a composite Video Banking Sync (CVBS) terminal, a component terminal, an S-video terminal (analog), a Digital Visual Interface (DVI) terminal, a High Definition Multimedia Interface (HDMI) terminal, an RGB terminal, a D-SUB terminal, etc., to input video and audio signals of the external device to the display device 100.

The wireless communication unit may perform a short-distance wireless communication with other electronic devices. For example, communication standards such as Bluetooth, Radio Frequency Identification (RFID), infrared Data Association (IrDA), Ultra Wideband (UWB), ZigBee, Digital Living Network Alliance (DLNA), etc. can be used for the short-distance wireless communication, whereby network connection between the display device 100 and other electronic devices can be performed.

In addition, the external device interface module 135 may be connected to various set-top boxes through at least one of the above-mentioned various terminals to perform input/output operation with the set-top boxes.

In the mean time, the external device interface module 135 receives an application of a neighboring external device or list of applications and transmits the received application or the list of applications to the control module 170 or the memory module 140.

The network interface module 130 provides interface for connecting the display device 100 with wire/wireless networks including Internet network. The network interface module 130 may include an Ethernet terminal, for example, for wire network connection. Also, for example, Wireless LAN (WLAN) (Wi-Fi), Wireless broadband (Wibro), World Interoperability for Microwave Access (Wimax), High Speed Downlink Packet Access (HSDPA) can be used for the wireless network connection.

The network interface module 130 transmits or receives data to and from other users or other electronic devices through a network connected thereto or another network linked on the connected network. In particular, the network interface module 130 can transmit some contents data stored in the display device 100 to a user or electronic device selected from other users or electronic devices previously registered with the display device 100.

In the mean time, the network interface module 130 can access a predetermined web page through a network connected thereto or another network linked on the connected network. In other words, the network interface module 130 can transmit or receive data to and from a corresponding server by accessing the predetermined web page through the corresponding network. In addition, the network interface module 130 can receive contents or data provided by the content provider or the network operator. In other words, the network interface module 130 can receive contents such as movies, advertisements, games, VOD, broadcast signals, etc. and related information, which are provided from the content provider or the network provider through the network. Also, the network interface module 130 can receive update information and update files of firmware provided by the network operator. Moreover, the network interface module 130 can transmit data to the Internet or content provider or the network operator.

Furthermore, the network interface module 130 can selectively receive a desired one of contents open to the public, through the network.

Also, the network interface module 130 can transmit or receive contents or data of a list of contents to and from a predetermined server through the network.

The memory module 140 may store a program for processing and controlling each signal of the control module 170, or may store the processed video, audio or data signal.

Also, the memory module 140 may temporarily store the video, audio or data signal input from the external device interface module 135 or the network interface module 130. The memory module 140 may store information on a predetermined broadcast channel through a channel memory function.

Also, the memory module 140 may store the application or the list of applications input from the external device interface module 135 or the network interface module 130.

Also, the memory module 140 may store the contents or the list of contents input from the external device interface module 135 or the network interface module 130.

For example, the memory module 140 may include a storage medium of at least one type of a flash memory type, a hard disk type, a multimedia card micro type, a card type memory (for example, SD or XD memory), RAM and ROM (EEPROM, etc.) The display device 100 can play contents files (moving picture files, still image files, music files, application files, etc.) stored in the memory module 140 to provide the played contents files to the user.

Although FIG. 6 illustrates that the memory module 140 and the control module 170 are provided separately, the scope of the present invention is not limited by the embodiment of FIG. 6. The memory module 140 may be included in the control module 170.

The user input interface module 150 transmits the signal input by the user to the control module 170 or transmits the signal from the control module 170 to the user.

For example, the user input interface module 150 may receive a control signal such as power on/off, channel selection and screen setup from the remote controller 200 or transmit the control signal from the control module 170 to the remote controller 200 in accordance with various communication modes such as RF communication mode and IR communication mode.

Also, for example, the user input interface module 150 may transmit a control signal input by a local key (not shown) such as a power key, a channel key, a volume key, and a setup key to the control module 170.

Also, for example, the user input interface module 150 may transmit a control signal input by a sensing unit (not shown), which senses gesture of the user, to the control module 170, or may transmit the signal from the control module 170 to the sensing unit. In this case, the sensing unit may include a touch sensor, an audio sensor, a position sensor, an action sensor, etc.

Also, for synchronization and search of the contents stored in the display device, the user input interface module 150 may receive predetermined synchronization target content, a selection signal of the display device for synchronization, a content keyword, and a synchronization command from the user.

The control module 170 demultiplexes an input stream and processes the demultiplexed stream through the tuner 110, the demodulation module 120 or the external device interface module 130 to generate and output a signal for a video and audio output.

The video signal processed by the control module 170 may be input to the display module 180, so that the video signal may be displayed as image corresponding to the video signal. Also, the video signal processed by the control module 170 may be input to the external output device through the external device interface module 135.

The video signal processed by the control module 170 may be output to the audio output module 185. Also, the video signal processed by the control module 170 may be input to the external output device through the external device interface module 135.

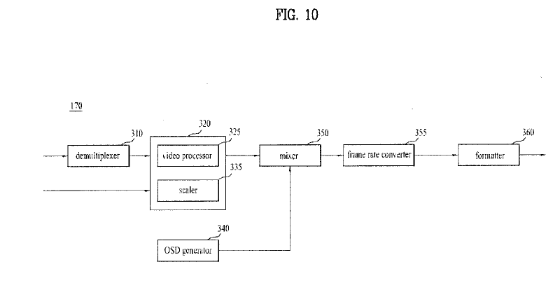

Although not shown in FIG. 6, the control module 170 may include a demultiplexer and a video processor, which will be described later with reference to FIG. 10.

In addition, the control module 170 controls overall operations of the display device 100. For example, the control module 170 may control the tuner 110 to tune RF broadcasting corresponding to the channel selected by the user or the previously stored channel.

Also, the control module 170 may control the display device 100 through a user command input through the user input interface module 150 or its internal program. In particular, the control module 170 may allow the user to access the network and download a desired application or a list of desired applications into the display device 100.

For example, the control module 170 controls the tuner 110 to input a signal of a channel selected in accordance with a predetermined channel selection command received through the user input interface module 150, and processes a video, audio or data signal of the selected channel. The control module 170 may allow the channel information selected by the user to be output through the display module 180 or the audio output module 185 together with the processed video or audio signal.

For another example, the control module 170 may allow a video signal or an audio signal from an external device, for example, camera or camcorder, which is input through the external device interface module 135, to be output through the display module 180 or the audio output module 185 in accordance with an external device video play command received through the user input interface module 150.

Also, the control module 170 may control the display device 100 through a user command input through the user input interface module 150 or its internal program. In particular, the control module 170 may allow the user to access the network and download a desired content or a list of contents into the display device 100.

In the mean time, the control module 170 may control the display module 180 to display video. For example, the control module 170 may control the display module 180 to display broadcasting image input through the tuner 110, external input image input through the external device interface module 135, image input through the network interface module, or image stored in the memory module 140. At this time, the image displayed in the display module 180 may be still image or moving image, and may be 2D image or 3D image.

In the mean time, if the control module 170 enters a contents viewing list, it may control the display module to display contents or a list of contents that can be downloaded in the display device 100 or from the external network.

Also, the control module 170 may play contents. At this time, the contents may be contents stored in the display device 100, received broadcasting contents, or externally input contents. The contents may be at least one of broadcasting image, external input image, audio files, still image, accessed web screen, and document files.

In the mean time, according to the embodiment of the present invention, the control module 170 may control the display module 180 to display a home screen in accordance with an input of movement to home screen.

The home screen may include a plurality of card objects sorted per content source. The card object may include at least one of a card object representing a thumbnail list of a broadcast channel, a card object representing a broadcast guide list, a card object representing a broadcasting reservation list or a broadcasting recording list, and a card object representing a media list within the display device or another device connected with the display device. Also, the card object may further include at least one of a card object representing a list of accessed external devices and a card object representing a list related with calls.

Also, the home screen may further include an application menu provided with at least one executable application list.

In the mean time, if there is an input of card object movement, the control module 170 may control the display module 180 to display the corresponding card object through movement or move a card object not displayed in the display module 180 to the display module 180.

If a predetermined one of a plurality of card objects in the home screen is selected, the control module 170 may control the display module 180 to display image corresponding to the corresponding card object.

In the mean time, the control module 170 may control the display module 180 to display received broadcasting image and an object representing corresponding broadcasting image information in the card object displaying broadcasting image. The control module 170 may control the broadcasting image such that the size of the broadcasting image may be fixed by lock.

The control module 170 may control the display module 180 to display a setup object for at least one of video setup, audio setup, reservation setup, pointer setup of the remote controller, and network setup in the home screen.

The control module 170 may control the display module 180 to display an object of login, help message, or exit in a part of the home screen.

The control module 170 may control the display module 180 to display an object representing the number of all card objects or representing the number of card objects displayed in the display module 180 in a part of the home screen.

In the mean time, if a card object name of a predetermined one of card objects displayed in the display module 180 is selected, the control module 170 may control display module 180 to display the corresponding card object as the whole screen.

Also, if an incoming call signal is received in the accessed external device or the display device, the control module 170 may control the display module 180 to focus and display a call related card object of a plurality of card objects or move the call related card object into the display module 180.

In the mean time, if the control module 170 enters an application viewing list, it may display an application or a list of applications that can be downloaded in the display device 100 or from the external network.

The control module 170 may control installation or driving of the application downloaded from the external network together with various user interfaces. Also, the control module 170 may control the display module 180 to display image related to the application implemented by selection of the user.

In the mean time, although not shown, a channel browsing processor that generates thumbnail image corresponding to a channel signal or external input signal may further be provided.

The channel browsing processor extracts image from the stream signal (TS) output from the demodulation module 120 or the stream signal output from the external device interface module 135 to generate thumbnail image. The thumbnail image may be input to the control module 170 as it is or encoded. Also, the generated thumbnail image may be encoded in a stream format and then input to the control module 170. Therefore, the control module 170 may display a thumbnail list that includes a plurality of thumbnail images, by using the input thumbnail image. The thumbnail images of the thumbnail list may be updated in due order or at the same time. Then, the user can simply recognize contents of a plurality of broadcast channels.

According to the embodiment of the present invention, for synchronization of contents of the display device, if contents for synchronization and a selection signal of the display device for synchronization are received from the user through the user input interface module 150, the control module 170 transmits the selection signal to a predetermined server through the network interface module 130. If a comparison result of the list of contents is received from the server, the control module 170 transmits the contents corresponding to the comparison result to the server.

According to another embodiment of the present invention, if contents for synchronization are received from the predetermined server through the network interface module 130, the control module 170 outputs a list of the received contents through the display module 180. If a synchronization confirmation command for the received contents is input from the user through the user input interface module 150, the control module 170 controls the memory module 140 to update the list of contents of the memory module 140.

Also, if contents for synchronization are received from the predetermined server through the network interface module 130, the control module 170 outputs a notification message to a predetermined zone of the display module 180. If a confirmation command for the received contents is input from the user through the user input interface module 150, the control module 170 controls the display module 180 to output a list of the received contents.

Also, the control module 170 may control the display module 180 to output the notification message together with image data corresponding to the received contents or information on the number of the received contents.

The control module 170 may control the memory module 140 such that the list of the received contents may additionally include contents previously stored in the memory module 140. Also, the control module 170 may control the display module to respectively display the received contents and the contents previously stored in the memory module.

According to another embodiment of the present invention, if a content search keyword and a selection signal of the display device for search are received from the user through the user input interface module 150, the control module 170 transmits the received search information to a predetermined server through the network interface module 130 and receives the search result from the server through the network interface module 130.

The display module 180 converts the video, data and OSD signals processed by the control module 170 or the video and data signals received from the external device interface module 135 to R, G, B signals, respectively, to generate driving signals.

Examples of the display module 180 may include PDP, LCD, OLED, flexible display, and 3D display.

In the mean time, a touch screen may be used as the display module 180, whereby the display module may be used as an input module as well as an output module.

According to the embodiment of the present invention, the display module 180 may output a user interface that includes contents or a list of contents for synchronization, which are stored in the memory module 140 for synchronization and search of contents, a contents synchronization menu, a synchronization notification message, and a contents search menu.

The audio output module 185 receives the signal audio-processed by the control module 170, for example, stereo signal, 3.1 channel signal or 5.1 channel signal, and outputs the received signal as sound. Various types of speakers may be used as the audio output module 185.

In the mean time, to sense gesture of the user, the display device 100 may further include a sensing unit (not shown) that includes at least one of a touch sensor, an audio sensor, a position sensor, and an action sensor, as described above. The signal sensed by the sensing unit may be transmitted to the control module 170 through the user input interface module 150.

The display device 100 may further include a camera module (not shown) that takes a user. Image information taken by the camera module may be input to the control module 170.

The control module 170 may sense gesture of the user by using the image taken from the camera module (not shown) and the signal sensed from the sensing unit, respectively or in combination.

The power supply module 190 supplies the corresponding power to the whole portion of the display device 100. In particular, the power supply module 190 can supply the power to the control module 170 that can be implemented in the form of a system on chip (SOC), the display module 180 for image display, and the audio output module 185 for audio output.

To this end, the power supply module 190 may further include a converter (not shown) that converts alternating current to direct current. In the mean time, if the display module 180 is implemented as a liquid crystal panel that includes a plurality of back light lamps, for example, for luminance variable or dimming driving, the power supply module 190 may further include an inverter (not shown) that enables PWN operation.

The remote controller 200 transmits a user input to the user input interface module 150. To this end, the remote controller 200 can use Bluetooth, Radio Frequency (RF) communication, infrared (IR) communication, Ultra Wideband (UWB), ZigBee, etc.

Also, the remote controller 200 can receive the video, audio or data signal output from the user input interface module 150 to display the received signal or output audio or vibration.

The aforementioned display device 100 may be a fixed type digital broadcast receiver that can receive at least one of digital broadcasting of ATSC mode (8-VSB mode), digital broadcasting of DVB-T mode (COFDM mode), and digital broadcasting of ISDB-T mode (BST-OFDM mode).

In the mean time, the block diagram illustrated in FIG. 2 is for one embodiment of the present invention. The respective elements of the block diagram may be incorporated, added or omitted depending on options of the display device 100 which is actually implemented. In other words, two or more elements may be incorporated into one element, or one element may be divided into two or more elements, as occasion demands. Also, the function performed by each block is intended for description of the embodiment of the present invention, and its detailed action or device does not limit claims of the present invention.

In the mean time, unlike the embodiment illustrated in FIG. 6, the display device 100 may receive and play video contents through the network interface module 130 or the external device interface module 135 without the tuner 110 and the demodulation module 120 illustrated in FIG. 6.

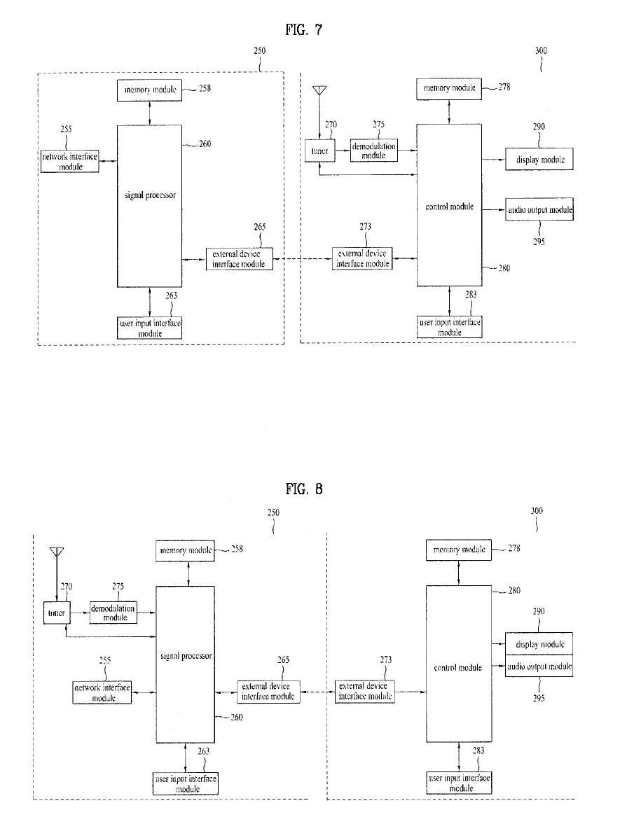

The display device 100 is an example of a video processor that performs signal processing of video stored therein or input video. Another examples of the video signal processor include a set-top box that excludes the display module 180 and the audio output module 185 illustrated in FIG. 6, the aforementioned DVD player, a blu-ray player, a game device, and a computer. Hereinafter, the set-top box will be described with reference to FIG. 7 and FIG. 8.

FIG. 7 and FIG. 8 showing embodiments of display devices divided into a set-top box and a displayer. First of all, referring to FIG. 7, a set-top box 250 and a displayer 300 can transmit or receive data through a wire or wireless cable.

The set-top box 250 includes a network interface module 255, a memory module 258, a signal processor 260, a user input interface module 263, and an external device interface module 265.

The network interface module 255 provides an interface for connection with wire/wireless network including Internet network. Also, the network interface module 255 transmits or receives data to and from other users or other electronic devices through a network connected thereto or another network linked on the connected network.

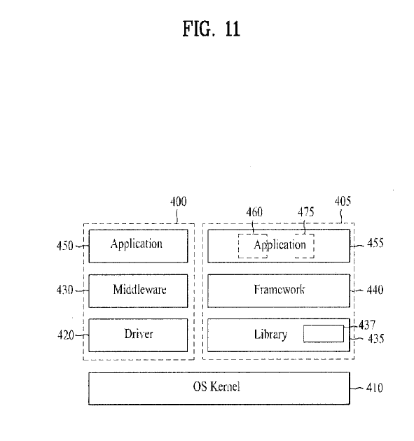

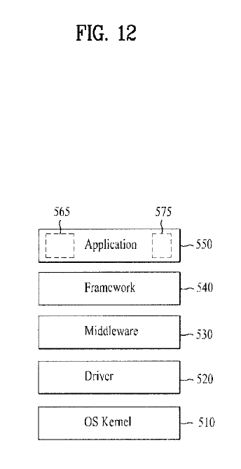

The memory module 258 may store a program for processing and controlling each signal of the signal processor 260, or may temporarily store the video, audio or data signal input from the external device interface module 265 or the network interface module 255. Also, the memory module 258 may store a platform illustrated in FIG. 11 and FIG. 12 which will be described later.

The signal processor 260 performs signal processing of an input signal. For example, the signal processor 260 may demultiplex or decode the input video signal, or may demultiplex or decode the input audio signal. To this end, the signal processor 260 may further include a video decoder or an audio decoder. The video signal or audio signal subjected to signal processing can be transmitted to the displayer 300 through the external device interface module 265.

The user input interface module 263 transmits the signal input by the user to the signal processor 260 or transmits the signal from the signal processor 260 to the user. For example, the user input interface module 263 may receive various control signals such as power on/off, action input and setup input, which are input by a local key (not shown) or a remote controller 200, to transmit the control signals to the signal processor 260.

The external device interface module 265 provides an interface for transmitting or receiving data to and from an external device connected thereto through a wire or wireless cable. In particular, the external device interface module 265 provides an interface for transmitting or receiving data to and from the displayer 300. In addition, the external device interface module 265 may provide an interface for transmitting or receiving data to and from external devices such as game devices, cameras, camcorders, computers (e.g., notebook computers), etc.

In the mean time, the set-top box 250 may further include a media input module (not shown) for playing separate media. An example of the media input module includes a blu-ray input module (not shown). In other words, the set-top box 250 may include a blu-ray player. Media of the input blu-ray disk are subjected to signal processing such as demultiplexing or decoding by the signal processor 260 and then transmitted to the displayer 300 through the external device interface module 265, whereby the media are displayed in the displayer 300.

The displayer 300 includes a tuner 270, an external device interface module 273, a demodulation module 275, a memory module 278, a control module 280, a user input interface module 283, a display module 290, and audio output module 295.

Since the tuner 270, the demodulation module 275, the memory module 278, the user input interface module 283, the display module 290, and the audio output module 295 correspond to the tuner 110, the demodulation module 120, the memory module 140, the user input interface module 150, the display module 180, and the audio output module 185, which are illustrated in FIG. 6, their description will be omitted.

In the mean time, the external device interface module 273 provides an interface for transmitting or receiving data to and from an external device connected thereto through a wire or wireless cable. In particular, the external device interface module 273 provides an interface for transmitting or receiving data to and from the set-top box 250.

Accordingly, the video signal or audio signal input through the set-top box 250 is output to the display module 180 or the audio output module 185 through the control module 170.

In the mean time, referring to FIG. 8, the set-top box 250 and the displayer 300 are similar to those illustrated in FIG. 7 but are different from those illustrated in FIG. 7 in that the tuner 270 and the demodulation module 275 are located in the set-top box 250 not the displayer 300. Hereinafter, the set-top box 250 and the displayer 300 of FIG. 8 will be described based on the difference from FIG. 7.

The signal processor 260 performs signal processing of a broadcast signal received through the tuner 270 and the demodulation module 275. Also, the user input interface module 263 receives an input signal of channel selection, channel storage, etc.

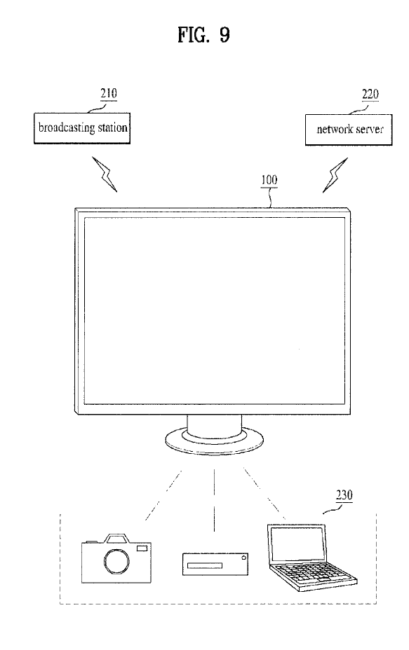

FIG. 9 is a diagram illustrating a communication procedure between any one of display devices according to the embodiments of the present invention and third devices. The display device illustrated in FIG. 9 may correspond to any one of the display devices according to the aforementioned embodiments of the present invention.

As illustrated in FIG. 9, one embodiment of the display device 100 performs communication with a broadcasting station 210, a network server 220, or an external device 230. The display device 100 receives a broadcast signal that includes a video signal transmitted from the broadcasting station 210. The display device 100 processes the video signal included in the broadcast signal and audio or data signal to be appropriately output from the display device 100. The display device 100 outputs video or audio based on the processed signal.

In the mean time, the display device 100 can perform communication with the network server. The network server 220 can transmit and receive a signal to and from the display device 100 through a random network. For example, the network server 220 may be a portable terminal that can be connected with the display device 100 through a wire or wireless base station. Also, the network server 220 may be a device that can provide contents to the display device 200 through Internet network. The content provider can provide contents to the display device by using the network server.

The display device 100 can perform communication with the external device 230. The external device 230 can directly transmit and receive a signal to and from the display device 100 through a wire or wireless cable. For example, the external device 230 may be a media memory device or a media player, which is used by the user. In other words, the external device 230 corresponds to a camera, a DVD player, a blu-ray player, or a personal computer.

The broadcasting station 210, the network server 220 or the external device 230 can transmit a signal, which includes a video signal, to the display device 100. The display device 100 can display video based on the video signal included in the input signal. Also, the display device 100 can transmit the signal, which is transmitted from the broadcasting station 210 or the network server 220 to the display device 100, to the external device 230. Also, the display device 100 can transmit the signal, which is transmitted from the external device 230 to the display device 100, to the broadcasting station 210 or the network server 220. In other words, the display device 100 serves to directly play and transmit the contents included in the signal transmitted form the broadcasting station 210, the network server 220 and the external device 230.

FIG. 10 is a block diagram illustrating the inside of control module 170, which includes a demultiplexer 310, a video processor 320, an OSD generator 340, a mixer 350, a frame rate converter 355, and a formatter 360. The control module 170 may further include an audio processor (not shown) and a data processor (not shown).

The demultiplexer 310 demultipelxes input streams. For example, if MPEG-2 TS is input, the demultiplexer 310 demultiplexes the MPEG-2 TS and splits the demultiplexed MPEG-2 TS into a video signal, an audio signal and a data signal. In this case, the stream signal input to the demultiplexer 310 may be the stream signal output from the tuner 110, the demodulation module 120, or the external device interface module 135.

The video processor 320 can process the demultiplexed video signal. To this end, the video processor 320 includes a video decoder 325 and a scaler 335.

The video decoder 325 decodes the demultiplexed video signal, the scaler 335 performs scaling to output resolution of the decoded video signal through the display module 180.

The video decoder 325 may include decoders having various specifications.

For example, if the demultiplexed video signal is an encoded video signal of the MPEG-2 specification, it may be decoded by an MPEG-2 decoder.

Also, for example, if the demultiplexed video signal is an encoded video signal of the H.264 specification based on a Digital Multimedia Broadcasting (DMB) mode or DVB-H mode, it may be decoded by an H.264 decoder.

In the mean time, the video signal decoded by the video processor 320 is input to the mixer 350.

The OSD generator 340 generates an OSD signal in accordance with input of the user or by itself. For example, the OSD generator 340 may generate a signal for displaying various kinds of information on the screen of the display module 180 in the form of graphic or text based on the control signal from the user input interface module 150. The generated OSD signal may include various data such as a user interface screen of the display device 100, a screen of various menus, widget, and icon.

For example, the OSD generator 340 may generate a signal for displaying broadcast information based on EPG or caption of broadcast video.

The mixer 350 mixes the OSD signal generated by the OSD generator 340 with the decoded video signal processed by the video processor 220. The mixed signal is provided to the formatter 360. As the decoded broadcast video signal or the external input signal is mixed with the OSD signal, the OSD may be overlaid on the broadcast video or the external input video.

The frame rate converter (FRC) 355 converts a frame rate of the input video. For example, the frame rate converter 355 converts a frame rate of 60 Hz to a frame rate of 120 Hz or 240 Hz. If the frame rate converter 355 converts the frame rate of 60 Hz to the frame rate of 120 Hz, a first frame may be inserted between another first frame and the second frame, or a third frame predicted from the first frame and the second frame may be inserted between the first frame and the second frame. If the frame rate converter 355 converts the frame rate of 60 Hz to the frame rate of 240 Hz, three same frames may be inserted between another first frame and the second frame, or the third frame predicted from the first frame and the second frame may be inserted between the first frame and the second frame. In the mean time, the input frame rate may be maintained without separate conversion.

The formatter 360 receives an output signal of the frame rate converter 355, changes a format of the signal to conform to the display module 180, and then outputs the changed format. For example, the formatter 360 may output R, G, B data signals. The R, G, B data signals may be output by low voltage differential signaling (LVDS) or mini-LVDS.

In the mean time, the audio processor (not shown) in the control module 170 may perform audio processing of the demultiplexed audio signal. To this end, the audio processor may include various decoders.

If the demutliplexed audio signal is an encoded audio signal, the audio processor in the control module 170 may decode the encoded audio signal. For example, the demultiplexed audio signal may be decoded by an MPEG-2 decoder, MPEG-4 decoder, AAC decoder, or AC-3 decoder.

Also, the audio processor in the control module 170 can process base, treble and sound volume control.

The data processor (not shown) in the control module 170 can perform data processing of the demultiplexed data signal. If the demutliplexed data signal is an encoded data signal, the data processor in the control module 170 may decode the encoded data signal. The encoded data signal may be electronic program guide (EPG) information that includes broadcast information such as start time and end time of a broadcast program broadcasted from each channel. For example, the EPG information may be ATSC-Program and System information protocol (ATSC-PSIP) information in case of the ATSC mode, and may include DVB-Service Information (DVB-SI) in case of the DVB mode.

The ATSC-PSIP information or the DVB-SI information may be information included in the aforementioned stream, i.e., a header (4 byte) of the MPEG-2 TS.

In the mean time, since the block diagram of the control module 170 illustrated in FIG. 10 is for one embodiment, other modules may be added to the respective elements of the block diagram in accordance with the needs of those skilled in the art, or some of the modules or elements illustrated in FIG. 10 may be omitted.

FIG. 11 shows an example of a platform structure of a display device, and FIG. 12 shows another example of such a platform structure. The platform may include OS-based software to perform the aforementioned various operations.

First of all, referring to FIG. 11, a platform of any one of the display devices may be a split-type platform and can be designed in such a manner that it is split into a legacy system platform 400 and a smart system platform 405. An OS kernel 410 may be used in common for the legacy system platform 400 and the smart system platform 405.

The legacy system platform 400 includes a driver 420 on the OS kernel 410, a middleware 430, and an application layer 450.

The smart system platform 405 includes a library 435 on the OS kernel 410, a framework 440, and an application layer 455.

The OS kernel 410 is a core of the operating system, and can perform at least one of driving of a hardware driver, security of hardware and processor in the display device, efficient management of system resources, memory management, interface for hardware based on hardware abstraction, multi-process, and schedule management based on multi-process when the display device is driven. In the mean time, the OS kernel 410 may further perform power management.

The hardware driver in the OS kernel 410, for example, may include a display driver, a Wi-Fi driver, a Bluetooth driver, a USB driver, an audio driver, a power manager, a binder driver, and a memory driver.

Also, the hardware driver in the OS kernel 410 may further include a character device driver, a block device driver, and a network device driver as drivers for hardware devices therein. The block device driver may need a buffer equivalent to unit size in accordance with data transmission of a specific block unit. The character device driver may not need a buffer due to data transmission in a basic data unit, i.e., character unit.

As described above, the OS kernel 410 can be implemented as the kernel based on various operating systems such as unix (linux) based operating system and window based operating system. Also, the OS kernel 410 is an opened OS kernel, and can be used generally by other electronic devices.

The driver 420 is located between the OS kernel 410 and the middleware 430, and drives the device for operation of the application layer 450 together with the middleware 430. For example, the driver 420 may include drivers such as a micom in the display device, a display module, a graphic processing unit (GPU), a frame rate converter (FRC), a general purpose input/output pin (GPIO), HDMI, system decoder or demultiplexer (SDEC), video decoder (VDEC), audio decoder (ADEC), a personal video recorder (PVR), and an inter-integrated circuit (I2C). These drivers interact with the hardware driver in the OS kernel 410.

Also, the driver 420 may further include a driver of a remote controller 200, especially a spatial remote controller which will be described later. The driver of the spatial remote controller may be provided in the OS kernel 410 or the middleware 430 in addition to the driver 420.

The middleware 430 is located between the OS kernel 410 and the application layer 450, and serves as a medium that allows data to be exchanged between hardware and software. In this case, a standardized interface can be provided, various environments can be supported, and mutual interaction between tasks of different systems can be performed.

Examples of the middleware 430 in the legacy system platform 400 include data broadcasting related middleware, i.e., multimedia and hypermedia information coding experts group (MHEG) middleware and advanced common application platform (ACAP) middleware, broadcast information related middleware, i.e., PSIP middleware and SI middleware, and peripherals communication related middleware, i.e., DLNA middleware.

The application layer 450 on the middleware 430, namely the application layer 450 in the legacy system platform 400 may include a user interface application on various menus in the display device. The application layer 450 on the middleware 430 can be edited by selection of the user, and can be updated through the network. This application layer 450 enables the user to input a desired menu of various user interfaces in accordance with input of the remote controller during viewing broadcasting image.

Also, the application layer 450 in the legacy system platform 400 may further include at least one of TV guide application, Bluetooth application, reservation application, digital video recorder (DVR) application, hot key application.

In the mean time, the library 435 in the smart system platform 405 is located between the OS kernel 410 and the framework 440, and can form the base of the framework 440. For example, the library 435 includes security library, web engine library and media library, wherein the security library includes secure socket layer (SSL), the web engine library includes WebKit, libc (c library), and video and audio formats, and the media library includes media framework. The library 435 can be made based on C or C++, and can be exposed to a developer through the framework 440.

The library 435 may include a runtime 437 that includes a core java library and a virtual machine (VM). The runtime 437 forms the base of the framework 440 together with the library 435.

The virtual machine (VM) may be a virtual machine that enables a plurality of instances, i.e., multi-tasking. The virtual machine (VM) may be allocated in accordance with each application in the application layer 455. At this time, for schedule adjustment and interconnection between the plurality of instances, the binder driver (not shown) in the OS kernel 410 may be driven.

In the mean time, the binder driver and the runtime 437 can connect java based application with C based library.

The binder driver and the runtime 437 can correspond to middleware of the legacy system.

The framework 440 in the smart system platform 405 includes a program based on the application in the application layer 455. The framework 440 is compatible with any one of the applications and enables reuse, movement or exchanges of components. The framework 440 may include a support program, and a program that compiles other software elements. For example, the framework 440 may include a resource manager, an activity manager related to activities of the application, a notification manager, and a content provider for briefing of information shared between the applications. The framework 440 can be made based on JAVA.

The application layer 455 on the framework 440 includes various programs that can be driven and displayed in the display device 100. For example, the application layer 455 may include core application that includes at least one of email, short message service (SMS), calendar, map, and browser. This application layer 455 can be made based on JAVA.

Also, the application layer 455 can be divided into application 465 that can be stored in the display device 100 and cannot be deleted by the user and application 475 that can be downloaded through the external device or network and can freely be installed or deleted by the user.

Internet phone service, video on demand (VOD) service, web album service, social networking service (SNS), location based service (LBS), map service, web search service and application search service may be performed by network access through the application in the application layer 455. Also, various functions such as games and schedule management may be performed through the application in the application layer 455.

In the mean time, referring to FIG. 12, a platform of any one of the display devices according to the embodiments of the present invention is an integrated type platform and includes an OS kernel 510, a driver 520, a middleware 530, a framework 540, and an application layer 550.

The platform of FIG. 12 is different from that of FIG. 11 in that the library 435 illustrated in FIG. 11 is omitted and the application layer 550 is an integrated layer. The driver 520 and the framework 540 correspond to those of FIG. 11.

In the mean time, the platform of FIG. 12 can be designed such that the library 435 illustrated in FIG. 11 is incorporated into the middleware 530 illustrated in FIG. 12. In other words, the middleware 530 includes legacy system middleware and display system middleware. The legacy system middleware may include data broadcasting related middleware, i.e., multimedia and hypermedia information coding experts group (MHEG) middleware and advanced common application platform (ACAP) middleware, broadcast information related middleware, i.e., PSIP middleware and SI middleware, and peripherals communication related middleware, i.e., DLNA middleware. The display system middleware may include security library, web engine library and media library, wherein the security library includes secure socket layer (SSL), the web engine library includes WebKit, libc, and the media library includes media framework. The display system middleware may further include runtime described above.

The application layer 550 in the legacy system may include menu application, TV guide application, and reservation application while the application layer 55 in the display system may include email, short message service (SMS), calendar, map, and browser.

In the mean time, the application layer 550 may be divided into application 565 that can be stored in the display device 100 and cannot be deleted by the user and application 575 that can be downloaded through the external device or network and can freely be installed or deleted by the user.

In the mean time, based on the aforementioned platforms of FIG. 11 and FIG. 12, various API (Application Programming Interface) and SDK (Software Development Kit) can be opened for an application development. In the future or present time. Moreover, API can be implemented by calling the function that provides a connection to specific subroutine for implementation in a program.

For example, Those API and SDK can be opened by a source involved with hardware driver in OS kernel 410 such as display driver, Wi-fi driver, Bluetooth driver, USB driver, Audio driver, and so on. According to other embodiment of the present invention, those API and SDK can be opened by a related source in a driver 420 such as a micom in the display device, a display module, a graphic processing unit (GPU), a frame rate converter (FRC), system decoder or demultiplexer (SDEC), video decoder (VDEC), audio decoder (ADEC), a spatial remote controller and so on. According to another embodiment of the present invention, those API and SDK can be opened by a related source such as PSIP involved with broadcasting information, SI middleware or DLNA middleware.

Any developers can develop at least one of application that is used for display device 100 control or ran in display device 100 based on the aforementioned platforms of FIG. 11 and FIG. 12 by using those various open API.

The aforementioned platforms of FIG. 11 and FIG. 12 can be used generally for various electronic devices as well as the display device. In the mean time, the platforms of FIG. 11 and FIG. 12 may be stored or loaded in the memory module 140 or the control module 170 illustrated in FIG. 6 or a separate processor (not shown). Also, the platforms of FIG. 11 and FIG. 12 may be stored or loaded in the SI&Metadata DB 711, the UI manager 714 or the service manager 713 illustrated in FIG. 7. Also, a separate application processor (not shown) for implementing application may further be provided.

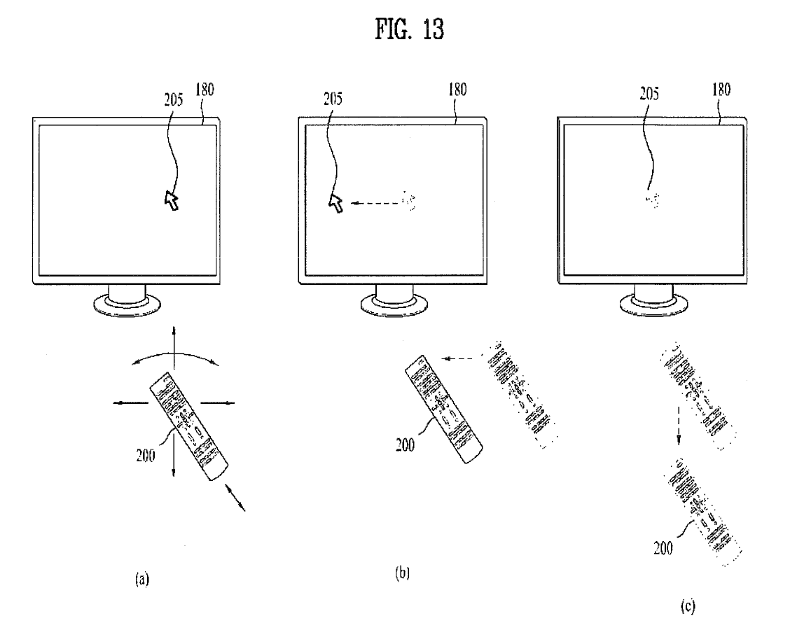

FIG. 13 shows one embodiment of a method for controlling a remote controller that controls any one of a variety of display devices. As illustrated in (a) of FIG. 13, a pointer 205 corresponding to the remote controller 200 is displayed in the display module 180.

The user can move or rotate the remote controller 200 in up and down direction and left and right direction (b of FIG. 13) and in front and rear direction (c of FIG. 13). The pointer 205 displayed in the display module 180 of the display device corresponds to movement of the remote controller 200. Since the remote controller 200 moves to the corresponding pointer 205 in accordance with movement on 3D space as shown, it may be referred to as a spatial remote controller.

(b) of FIG. 13 illustrates that, if the user moves the remote controller 200 to the left, the pointer 205 displayed in the display module 180 of the display device moves to the left correspondingly.

Information on movement of the remote controller 200, which is sensed by a sensor of the remote controller 200, is transmitted to the display device. The display device can obtain a coordinate of the pointer 205 from the information on movement of the remote controller 200. The display device can display the pointer 205 to correspond to the above coordinate.

(c) of FIG. 13 illustrates that the user moves the remote controller 200 to be far away from the display module 180 in a state that the user pushes a specific button of the remote controller 200. In this case, a zone selected in the display module 180 corresponding to the pointer 205 is displayed through zoom-in. On the contrary, if the user moves the remote controller 200 to be close to the display module 180, the zone selected in the display module 180 corresponding to the pointer 205 is displayed through zoom-out. In the mean time, if the remote controller 200 becomes far away from the display module 180, the selected zone may be subjected to zoom-out. If the remote controller 200 becomes close to the display module 180, the selected zone may be subjected to zoom-in.

In the mean time, in a state that the specific button of the remote controller 200 is pushed, up and down movement and left and right movement may not be recognized. In other words, if the remote controller 200 moves to be far away from or close to the display module 180, front and rear movement may be recognized only without recognition of up and down movement and left and right movement. In a state that the specific button of the remote controller 200 is not pushed, the pointer 205 is only moved in accordance with up and down movement and left and right movement of the remote controller 200.

Movement speed or movement direction of the pointer 205 may correspond to that of the remote controller 200.

In this specification, the pointer means an object displayed in the display module 180 to correspond to action of the remote controller 200. Accordingly, in addition to an arrow shape illustrated by the pointer 205, various shaped objects may be provided. For example, examples of the pointer may include dot, cursor, prompt, and thick outline. The pointer may be displayed to correspond to any one point of a horizontal axis and a vertical axis on the display module 180, or may be displayed to correspond to a plurality of points such as line and surface.

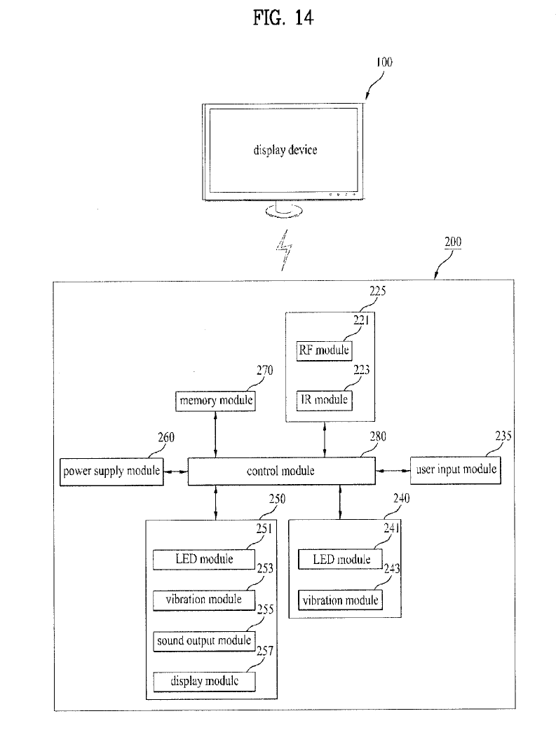

FIG. 14 shows one example of an interior design of a remote controller that controls a display device. The remote controller 200 includes a wireless communication module 225, a use input module 235, a sensor module 240, an output module 250, a power supply module 260, memory module 270, and control module 280.

The wireless communication module 225 transmits and receives a signal to and from any one of the aforementioned display devices. According to one embodiment, the remote controller 200 may include RF module 221 that can transmit and receive a signal to and from the display device 100 in accordance with the RF communication standard. The remote controller 200 may further include IR module 223 that can transmit and receive a signal to and from the display device 100 in accordance with the IR communication standard.

In this embodiment, the remote controller 200 transmits a signal, which includes information on its movement, to the display device 100 through the RF module 221.

Also, the remote controller 200 can receive the signal transmitted from the display device 100 through the RF module 221. Also, the remote controller 200 can transmit a command on power on/off, channel change and volume change to the display device 100 through the IR module 223.

The user input module 235 can include a key pad, a button, a touch pad, or a touch screen. The user can input the command related to the display device 100 to the remote controller 200 by manipulating the user input module 235. If the user input module 235 includes a hard key button, the user can input the command related to the display device 100 to the remote controller 200 through a push action of the hard key button. If the user input module 235 includes a touch screen, the user can input the command related to the display device 100 to the remote controller 200 by touching a soft key of the touch screen. Also, the user input module 235 may include various kinds of input means, which can be manipulated by the user, such as scroll key and jog key, within the range that does not limit the scope of the present invention.

The sensor module 240 may include a gyro sensor 241 or an acceleration sensor 243. The gyro sensor 241 can sense the information on movement of the remote controller 200. For example, the gyro sensor 241 can sense the information on movement of the remote controller 200 based on x, y and z axes. The acceleration sensor 243 can sense information on movement speed of the remote controller 200. In the mean time, the sensor module 240 may further include a distance sensor that senses the distance between the display module 180 and the remote controller 200.

The output module 250 can output the video or audio signal corresponding to the manipulation of the user input module 235 or the signal transmitted from the display device 100. The user can recognize whether the user input module 235 has been manipulated or whether the display device 100 has been controlled, through the output module 250.

For example, if the user input module 235 is manipulated or if the output module 250 transmits and receives a signal to and from the display device 100 through the wireless communication module 225, the output module 250 may include an LED module 251 for lighting, a vibration module 253 that generates vibration, a sound output module 255 that outputs sound, or a display module 257 that outputs image.

The power supply module 260 supplies the power to the remote controller 200. If the remote controller 200 does not move for a predetermined time, the power supply module 260 can save the power by stopping power supply. The power supply module 260 can resume power supply if a predetermined key provided in the remote controller 200 is manipulated.

The memory module 270 may store various kinds of programs and application data required for control or operation of the remote controller 200. If the remote controller 200 transmits and receives a signal to and from the display device 100 through the RF module 221, the remote controller 200 and the display device 100 transmit and receive the signal to and from each other through a predetermined frequency band. The control module 280 of the remote control module 200 can store information on the frequency band, which can be transmitted and received to and from the display device 100 paired with the remote controller 200, and can refer to the stored information.

The control module 280 controls all matters related to control of the remote controller 200. The control module 280 can transmit the signal corresponding to predetermined key manipulation of the user input module 235 or the signal corresponding to movement of the remote controller 200, which is sensed by the sensor module 240, to the display device through the wireless communication module 225.

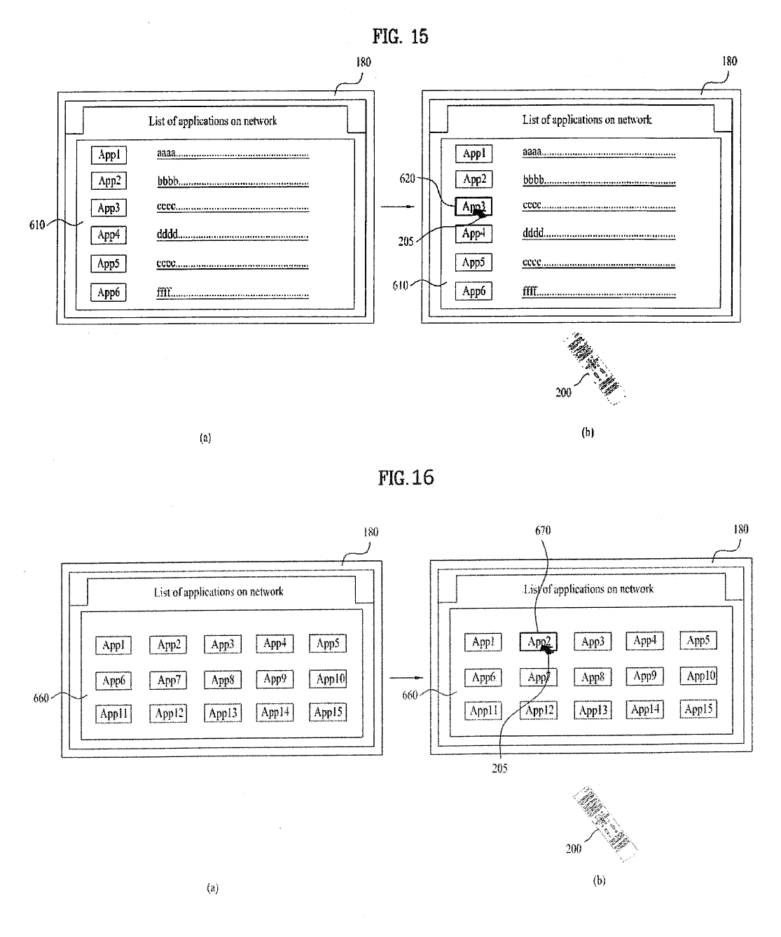

FIG. 15 shows a first example of a user interface on a display device. In FIG. 15, the list of applications on the network is displayed in the display module 180. In other words, the user can search and download various applications by directly accessing the corresponding content server or network server.

In (a) of FIG. 15, a list 610 of various applications in the accessed server is displayed in the display module 180. The list 610 of applications may include icon representing each application and brief information on each application. In the mean time, since the display device according to the embodiments of the present invention enables full browsing, it can display the icon or brief information received from the server through zoom-in. In this case, the user can easily identify the list of applications. This will be described later.

In (b) of FIG. 15, any one 620 of the list 610 of applications is selected using the pointer 205 of the remote controller 200. In this case, the corresponding application can be downloaded conveniently.

FIG. 16 shows another example of a user interface, in which a list of applications in the display device is displayed in the display module 180. First of all, in (a) of FIG. 16, if the user views the list of applications by manipulating the remote controller 200, the list 660 of applications stored in the display device according to the embodiments of the present invention is displayed in the display module 180. Although the icons representing each application are only shown in the drawing, the present invention is not limited to the icons. The list of applications may include the brief information on each application as illustrated in FIG. 15, whereby the user can easily identify the list of applications.

Next, in (b) of FIG. 16, any one 670 of the corresponding list 660 of applications is selected using the pointer 205 of the remote controller 200. In this case, the corresponding application can be implemented conveniently.

In the mean time, in order to select a predetermined item, the pointer 205 moves in accordance with movement of the user by using the remote controller 200 illustrated in FIG. 15 and FIG. 16. Also, in the embodiment of the present invention, various examples for selecting a predetermined item may be provided. For example, a cursor displayed on the screen by combination of a directional key and a confirmation key, which are arranged in a local key (not shown) or the remote controller 200, may be used to select a predetermined item.

For another example, if the remote controller 200 includes a touch pad, the pointer 205 is moved on the display module 180 by touch action of the touch pad. In this way, a predetermined item may be selected.

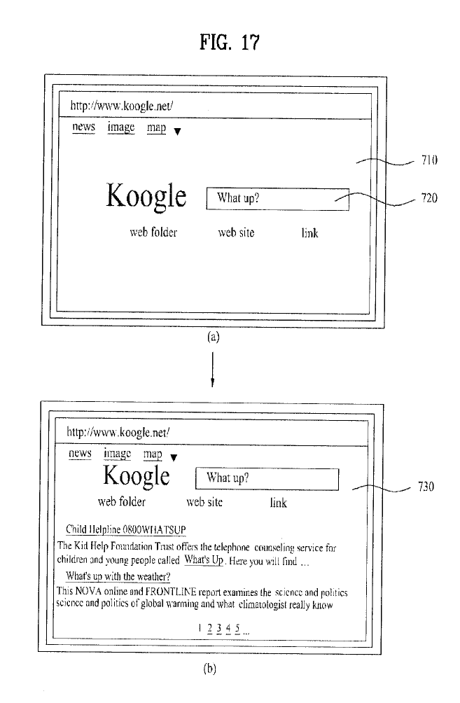

FIG. 17 shows another example of a user interface, which illustrates that a web screen is displayed in the display module of the display device. First of all, in (a) of FIG. 17, a predetermined web screen 710 that includes a search window 720 is displayed in the display module 180. The user can input a predetermined text in the search window 720 by using a key pad (not shown) displayed on the screen, a text key (not shown) provided in a local key (not shown), or a text key (not shown) provided in the remote controller.

Next, (b) of FIG. 17 illustrates that a search result screen 730 according to a search keyword input to the search window is displayed in the display screen 180. Since the display device according to the embodiment of the present invention enables full browsing, the user can easily identify the web screen.

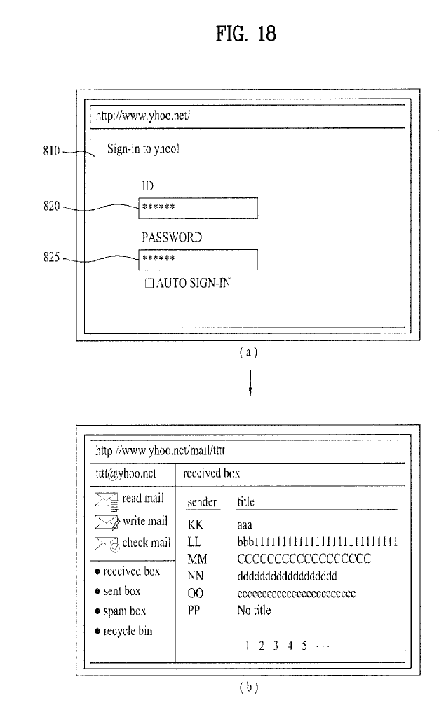

FIG. 18 shows another example of a user interface, in which a web screen is displayed in the display portion of the display device. First of all, in (a) of FIG. 18, a mail service screen 810 having an ID input window 820 and a password input window 825 is displayed in the display module 180. The user can input a predetermined text in the ID input window 820 and the password input window 825 by using a key pad (not shown) displayed on the screen, a text key (not shown) provided in a local key (not shown), or a text key (not shown) provided in the remote controller. Accordingly, the user can log in the corresponding mail service.

Next, in (b) of FIG. 18, a screen 830 after log in mail service is displayed in the display module 180. For example, ‘read mail’ item, ‘write mail’ item, ‘sent box’ item, ‘received box’ item, and ‘recycle bin’ item may be displayed in the display module. Also, the ‘received box’ item may be divided into ‘sender’ item and ‘title’ item. In this way, the received mails may be arranged and displayed in the display module 180.

Since the display device according to the embodiment of the present invention enables full browsing when the screen for mail service is displayed, the user can use the mail service conveniently.

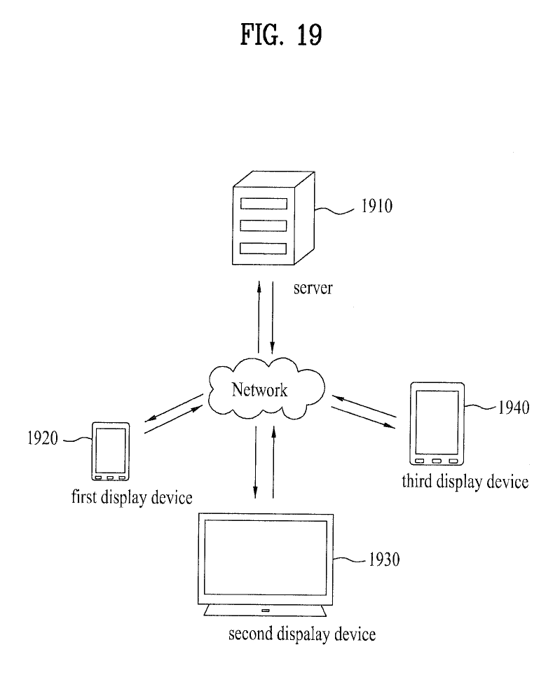

FIG. 19 shows an embodiment of a content synchronizing system which includes a predetermined server 1910 for storing contents data and a list of contents of the display device, a first display device 1920, a second display device 1930, and a third display device 1940, wherein predetermined contents are stored in the first, second and third display devices 1920, 1930 and 1940 and contents synchronization can mutually be performed among the first, second and third display devices.

Examples of the first display device, the second display device and the third display device as illustrated in FIG. 19 and following drawings include smart TVs, tablet PCs, mobile communication terminals, digital cameras, digital camcorders, a predetermined device having a displayer module such as a personal media player (PMP) and a set-top box type device having a separate display module. All means that can use and store contents can be used the display devices.

According to the embodiment of the present invention, the server 1910 may store contents data and the list of the contents data stored in the first display device, the second display device and the third display device, which are display devices connected to the network, compare the contents data of the display devices with one another in accordance with a synchronization request of each display device, and transmit the compared result to the display device. Alternatively, the server 1910 may store the contents transmitted from the display device and transmit the contents to other display device.

Also, the first display device 1920 may receive a display device for synchronization and contents for synchronization selected by the user and transmit a list of the selected contents to the server 1910 in accordance with the compared result.

Also, the second display device 1930 and the third display device 1940 may receive the contents for synchronization from the server 1910 and store the contents.

The network connection means may be a wire/wireless network that includes Internet network. The network connection means includes wire network connection through an Ethernet terminal of the first display device and wireless network connection based on Wireless LAN (WLAN) (Wi-Fi), Wireless broadband (Wibro), World Interoperability for Microwave Access (Wimax), and High Speed Downlink Packet Access (HSDPA).

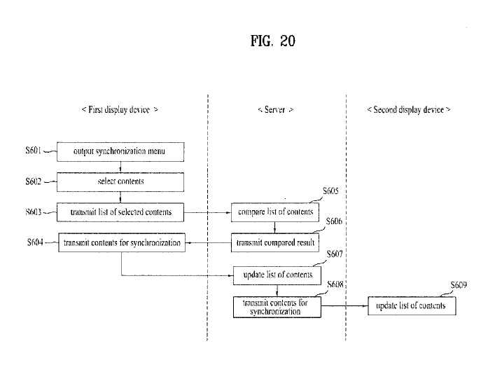

FIG. 20 shows an embodiment of a method for synchronizing contents which can be performed by the contents synchronization system that includes a first display device where contents for synchronization are stored, a second display device for synchronizing contents, and a predetermined server connected with the display devices through a network.

More specifically, FIG. 20 illustrates the procedure of determining the list of contents to be transmitted from the first display device to the second display device through the server and transmitting predetermined contents to the second display device through the server.

Referring to FIG. 20, according to one embodiment, the first display device outputs a contents synchronization menu through the user interface (S601). At this time, the contents synchronization menu may include a list of contents stored in the first display device, a thumbnail screen of the stored contents, and brief information for the stored contents.

If the contents synchronization menu is output, the first display device receives the list of contents for synchronization selected by the user (S602).

According to the embodiment of the present invention, the user may set a list of all contents stored in the first display device as a list of contents for synchronization, or may select and set desired ones of the contents stored in the first display device as a list of contents for synchronization.

Next, the user transmits the list of the selected contents to the server through the network (S603).

According to the embodiment, if the user sets all contents stored in the first display device to the list of contents for synchronization in step S602, the first display device transmits the list of all contents stored therein to the server. However, if the user selects and desires to synchronize desired ones of the contents stored in the first display device, the first display device outputs a menu screen for selecting contents for synchronization to allow the user to select predetermined contents, and transmits a list of the selected contents to the server through network.

The network connection means may be a wire/wireless network that includes Internet network. The network connection means includes wire network connection through an Ethernet terminal of the first display device and wireless network connection based on Wireless LAN (WLAN) (Wi-Fi), Wireless broadband (Wibro), World Interoperability for Microwave Access (Wimax), and High Speed Downlink Packet Access (HSDPA).

Next, the server compares the list of contents transmitted in step S603 with the list of contents stored in the second display device, and generates a list of contents for transmission, wherein the list of contents for transmission includes contents for transmission, which are included in the list of the transmitted contents but are not included in the list of contents stored in the second display device (S605).

According to one embodiment, for comparison of the list of contents, the server may compare metadata included in each list of contents with each other to determine whether the metadata are the same as each other.

Next, the server transmits the list of contents for transmission to the first display device through the network (S606).

The first display device transmits the corresponding contents to the server through the network in accordance with the list of contents for transmission (S604).

According to the embodiment, if the corresponding contents are included in the list of contents for transmission but are previously stored in the server, the contents may not be transmitted form the first display device to the server.

The server stores the transmitted contents and updates the list of contents of the first display device and list of contents of the second display device to include the transmitted contents (S607).

Next, the server transmits the transmitted contents to the second display device through the network (S608).

According to the embodiment, if the server transmits the transmitted contents to the second display device, a predetermined transcoding step may be performed such that the transmitted contents correspond to device characteristics of the second display device.

For example, if the transmitted contents are video data and resolution of video contents that can be supported by the second display device is restrictive, the server may perform transcoding for the transmitted contents to correspond to resolution of the video contents that can be supported by the second display device and then transmit the contents to the second display device.

In this case, the user can use the synchronized contents without separate transcoding even though device characteristics of the first display device are different from those of the second display device.

Next, the second display device stores the transmitted contents in its memory module and updates its list of contents to include the transmitted contents (S609).

Also, the second display device transmits the list of contents to the server through the network to update its list of contents stored in the server.

According to one embodiment, step S607 of updating the list of contents may be performed after the list of contents is compared with another list of contents in step S605 or after the compared result is transmitted from the server to the first display device in step S606, unlike FIG. 20.

Also, according to one embodiment, the server may be included in any one of the first display device and the second display device in a module type. For example, if the server is included in the first display device in a module type, the respective steps performed by the first display device and the server may be performed by the first display device. This is equally applied to the case where the server is included in the second display device in a module type.

Through the method for synchronizing contents, the user can select and synchronize contents stored in different display devices easily and conveniently.

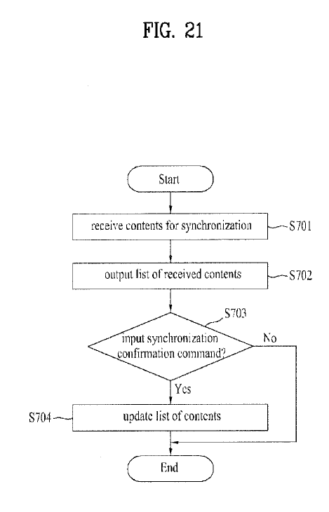

FIG. 21 shows another embodiment of a method for synchronizing contents. According to this embodiment, if contents for synchronization are received in a predetermined display device, the display device updates its list of contents through predetermined steps.

That is, the display device receives the contents for synchronization from a predetermined server or another display device through a network (S701). For the network connection, wire network connection through an Ethernet terminal of the display device and wireless network connection based on Wireless LAN (WLAN) (Wi-Fi), Wireless broadband (Wibro), World Interoperability for Microwave Access (Wimax), and High Speed Downlink Packet Access (HSDPA) can be used.

Next, the display device outputs the received list of contents to a display module of the display device (S702).

According to the embodiment, if the contents for synchronization are received, the display device outputs image data corresponding to a type of the received contents or a number corresponding to the number of the received contents in a predetermined zone of the display module. If an output signal of the list of the received contents is input by the user, the display device outputs the list of the received contents in the display module.

Also, according to the embodiment, the list of received contents may include the list of contents previously stored in the display device. If the list of received contents includes the list of contents previously stored in the display device, the display device may display the received contents and the previously stored contents, differently. An embodiment of the list of the received contents will be described in detail with reference to FIG. 29.

Next, the display device determines whether a synchronization confirmation command is input (S703).

According to one embodiment, the user determines whether the received contents should be synchronized in the second display device, by referring to the list of the received contents output in step S702, and outputs the synchronization contents command.

According to one embodiment, the synchronization confirmation command may include any one or more of a selection signal of a menu list included in the user interface and a key input signal of the display device or the remote controller.

If the synchronization confirmation command is input, the display device stores the received contents in the memory module of the display device and updates the list of contents of the display device (S704).

Also, the display device may transmit the updated list of contents to a predetermined server in accordance with the embodiment of the present invention.

Through the aforementioned method for synchronizing contents, the user can identify a type and the number of the synchronized contents even though the user is performing other task through the display device, and can conveniently determine whether to store the synchronized contents.

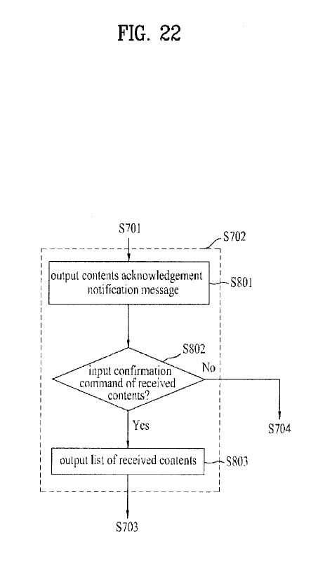

FIG. 22 is a detailed flow chart illustrating process steps of displaying a list of contents received in FIG. 21. Referring to FIG. 22, the step S702 of displaying the list of contents received in FIG. 21 may include a step S801 of displaying a contents acknowledgement notification message, a step of S802 of determining whether a confirmation command of the received contents is input, and a step S803 of displaying the list of the received contents.

If predetermined contents are received from a predetermined server, the display device outputs the contents acknowledgement notification message to the display module (S801).

According to one embodiment, the contents acknowledgement notification message may include image data corresponding to a type of the received contents or a number corresponding to the number of the received contents.

Next, the display device determines whether the confirmation command of the received contents is input (S802).

According to one embodiment, the confirmation command of the received contents recognizes the notification message as a confirmation menu for the received contents to receive a selection signal, or may be a key input signal of the display device or the remote controller.

If the confirmation command of the received contents is input from the user in step S802, the display device outputs the list of the received contents to the display module (S803).

As described above, the list of the received contents may include a list of contents previously stored in the display device, and the received contents and the previously stored contents may be displayed differently.

FIG. 23 shows an embodiment of a method for synchronizing contents, which can be performed by the first display device through which the user desires to use contents, the second display device through which the user desires to search contents, and the system connected with the server provided with contents and the list of contents through the network.

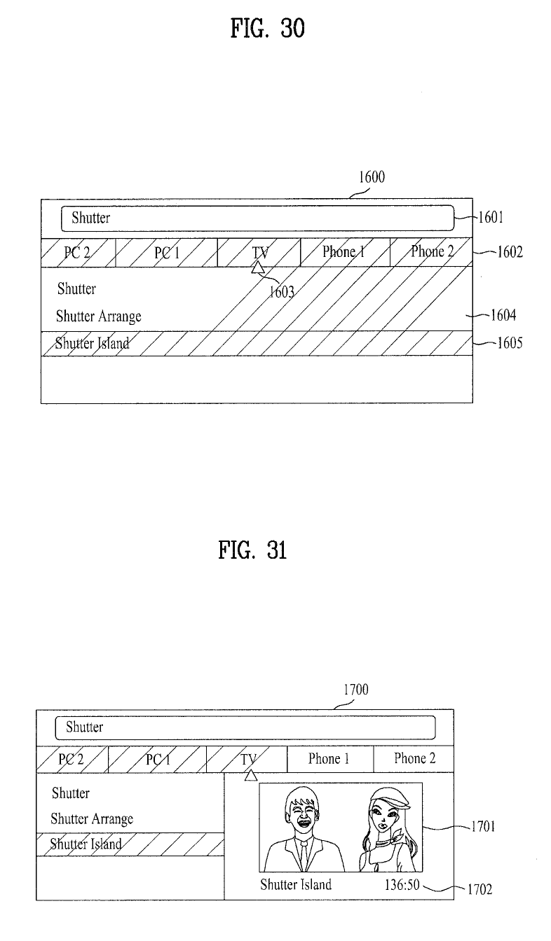

Referring to FIG. 23, the first display device outputs a user interface that includes a contents search menu (S901). The user interface includes any one or more of a search keyword input window and a selection menu for selecting a display device for search. The user interface will be described later in detail with reference to FIG. 30.

Next, the first display device receives a signal for selecting a search keyword and/or a display device for search (S902).

The first display device can input any one or more of the search keyword and the display device for search in accordance with the search menu output in step S901. The display device can receive the signal through the user input interface module 204. For example, the user can input a text for searching desired contents through the remote controller 205 and select a desired display device for search.

If the above information for search is input, the display device transmits the input information to the server through the network (S903).

The server can store the list of contents and contents data stored in the display device connected thereto through the network to the content database.

An Ethernet terminal of the first display device can be used for wire network transmission, and Wireless LAN (WLAN) (Wi-Fi), Wireless broadband (Wibro), World Interoperability for Microwave Access (Wimax), and High Speed Downlink Packet Access (HSDPA) can be for wireless network transmission.

In more detail, if the information for search is input through the user input interface module 150, the display device 100 transmits the information for search to the server through the network interface module 130.

If the information for search is received from the server, the server searches the contents database (S904).

The server searches the list of contents stored in the contents database to generate a list of contents corresponding to the input search keyword.

The server transmits the generated list of contents to the first display device (S906).

If the search result is transmitted from the server, the first display device outputs the search result to the display module of the first display device (S905).

According to one embodiment, the search result may include name of the searched content only, or may include detailed information on the content, such as preview screen and playing time. This will be described later in detail with reference to FIG. 31.

Next, the first display device selects contents to be used from the contents included in the search result (S907). The first display device receives a content selection signal through the user input interface module. If the content selection signal is received, the first display device transmits content selection information based on the received signal to the server (S908).

If the content selection information is received, the server transmits a content corresponding to the content selection information to the first display device through the network (S909).

According to one embodiment, if the server transmits the content corresponding to the content selection information to the first display device, a predetermined transcoding step may be performed such that the content corresponding to the content selection information corresponds to the device characteristics of the first display device.

For example, if the transmitted contents are video data and resolution of video contents that can be supported by the first display device is restrictive, the server may perform transcoding for the transmitted contents to correspond to resolution of the video contents that can be supported by the first display device and then transmit the contents to the first display device.

In this case, the user can use the content corresponding to the content selection information without separate transcoding even though device characteristics of the display device for search are different from those of the first display device.

The first display device receives contents from the server through the network and provides the received contents to the user (S910).

According to one embodiment, the user may receive data of the selected contents in real-time and play the received data in the first display device. Alternatively, the user may download all data of the selected contents to store the downloaded data in the first display device.

Through the aforementioned method for searching contents, the user can easily search contents stored in a separate display device and identify related information. Also, the user can conveniently use the searched contents.

FIG. 24 shows an embodiment of a user interface that includes a menu list for implementing contents synchronization. This user interface screen 1000 includes a type 1001 of contents stored in the display device and information 1003 on contents.

According to this embodiment, the user interface may include thumbnail image of contents, name of contents, date of contents, and user preference of contents.

Also, the user interface may include a menu list 1002 for implementing contents synchronization. Through the aforementioned user interface, the user can determine whether synchronization is implemented, while identifying contents currently stored in the display device.

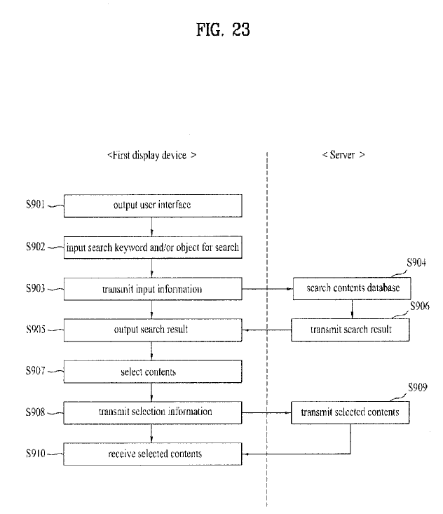

FIG. 25 shows another embodiment of a user interface that includes a selection menu of a list of contents for synchronization according to one embodiment of the present invention. In more detail, FIG. 25 illustrates a user interface screen 1100 that includes a menu 1101 for selecting a list of contents for synchronization.

According to this embodiment, the user may set all contents stored in the display device to be synchronized (S1102), or may set selected ones of contents stored in the display device to be synchronized (S1103).

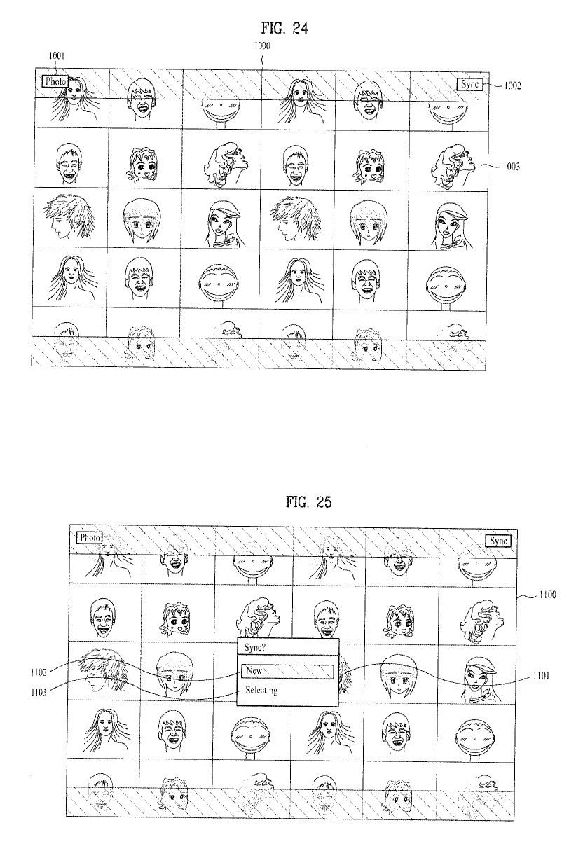

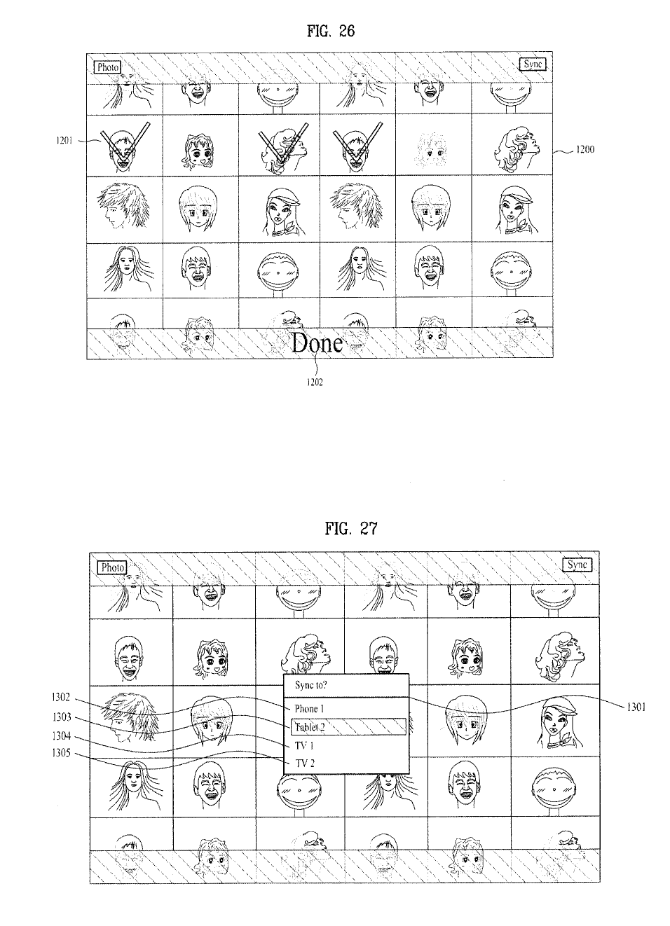

If all contents stored in the display device are set to be synchronized, a user interface illustrated in FIG. 27 is output such that the display device for synchronizing contents is selected. If selected ones of contents stored in the display device are set to be synchronized, a user interface illustrated in FIG. 26 is output such that predetermined contents for synchronization are selected.

FIG. 26 shows another embodiment of a user interface 1200 that includes a selection menu of contents for synchronization. This user interface screen 1200 includes a menu for selecting contents for synchronization.

More specifically, the user interface outputs a list of contents stored in the display device through the display module of the display device, and selects predetermined contents for synchronization from the contents included in the output list of contents.

According to this embodiment, the selected contents 1201 may be displayed differently from the contents which are not selected. For example, as illustrated in FIG. 26, the selected contents 1201 may be displayed in a V-check or opaque color, or may be displayed in a thick outline.

If selection of contents for synchronization is finished, the user selects a predetermined menu list 1202 and moves to next step for synchronizing contents. According to this embodiment, a menu screen for selecting a display device for synchronizing contents may be output.

FIG. 27 shows another embodiment of a user interface that includes a selection menu of a display device for synchronization. The user interface includes a menu 1301 for selecting a display device for synchronization according to the embodiment of the present invention. The menu 1301 for selecting a display device for synchronization includes a list of display devices connected with the network.

According to this embodiment, the list of display devices may be configured by searching the current network connection status, or may be configured by using the list of display devices previously stored. The display device may include all means, which can store and use contents, such as a mobile communication terminal 1302, a tablet terminal 1303, and broadcasting receiving terminals 1304 and 1305. The user can select one or more display devices, which will synchronize contents, from the list of display devices (S1303).

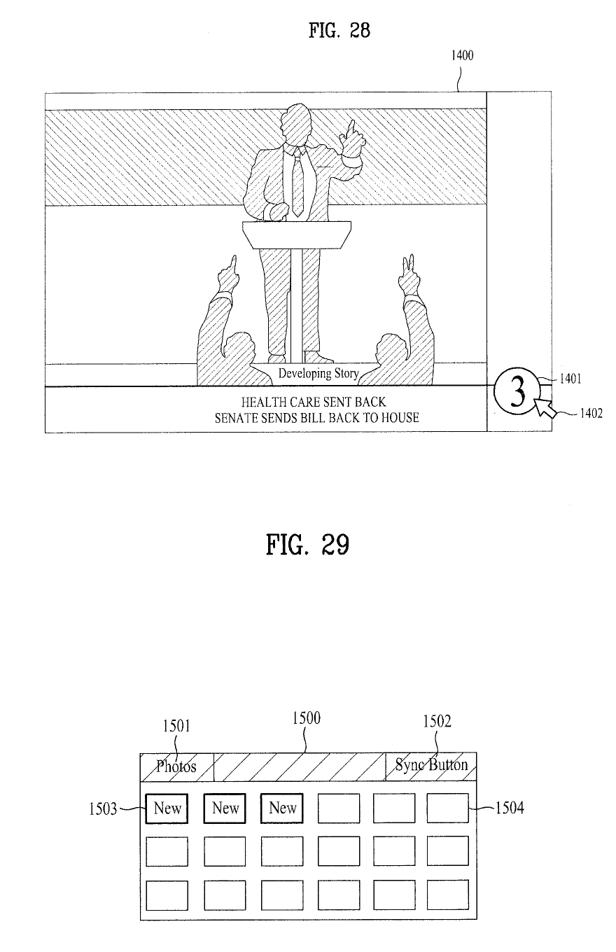

FIG. 28 shows another user interface that outputs a content synchronization notification message 1401 on a user interface screen 1400. According to this embodiment, if contents for synchronization are received from a predetermined server through the network in a state that the display device is displaying predetermined contents, the display device outputs the contents synchronization notification message 1401 to a predetermined zone of the display module.

According to this embodiment, the notification message may include information on received contents, image data corresponding to a type of the received contents and a number corresponding to the number of the received contents.

Also, if the notification message is selected by the user through a pointer 1402, or if a key input signal of the remote controller is received, the display device may output the list of received contents through the display module. The list of received contents will be described with reference to FIG. 29.

Through the user interface as above, the user can identify a type and the number of contents received for synchronization even though the user is performing other task through the display device.

FIG. 29 shows another embodiment of a user interface that includes a user interface screen 1500 that displays a list of received contents of the display device. According to this embodiment of the present invention, the user interface may display a type 1501 of the received contents, and may include a list of contents 1504 previously stored in the display device.

Also, the user interface may display the received contents and the contents previously stored in the display device, differently. In other words, the received contents 1503 may be displayed together with outline and ‘New’ text information, and the contents 1504 previously stored in the display device may be displayed by a dotted line or opaque color.

The user can update the list of contents previously stored in the display device by selecting a synchronization confirmation menu list 1502.

Through the aforementioned user interface, the user can clearly identify the contents received for synchronization and easily compare the contents previously stored in the display device with the received contents.

FIG. 30 shows a user interface screen 1600 that includes a search menu for searching contents of the display device. The search menu may include an input window 1601 for inputting a search keyword and a menu 1602 for selecting a display device for search.

According to the embodiment, text information related to contents to be searched by the user may be input to the input window 1601, and the menu for selecting the display device for search may be displayed in a type of a menu bar 1602 that includes a list of display devices that enables search. Also, one or more display devices may be selected (1603) from the list of display devices.

Also, the search menu may include a search result 1604 and a selection block 1605 for selecting contents to be used by the display device from the search result.

According to this embodiment, the selected contents and the contents which are not selected may be displayed differently. In other words, the selected contents 1605 may be displayed in a thicker font than that of the contents which are not selected. The contents which are not selected may be displayed in a thin font, dotted line, or opaque color. In addition, the selected contents 1605 and the contents 1604 which are not selected may be different from each other in font, color and outline design.

According to this embodiment, the user interface of FIG. 30 may further include detailed information on contents searched as illustrated in FIG. 31. Through the aforementioned user interface, the user can conveniently input a search keyword and select the display device for search in one screen.

FIG. 31 shows the aforementioned user interface 1700, which includes a contents detailed information screen. The user interface 1700 may include a preview screen 1701 of contents where a contents selection block of the search result is located, or a contents play time 1702. Also, the user interface may further include information such as contents date, contents data capacity, and user rating. Thorough the aforementioned user interface, the user can easily identify whether the contents included in the search result are the same as those to be used by the user.

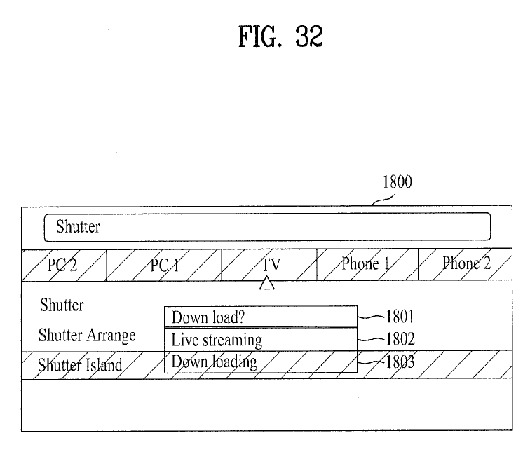

FIG. 32 shows another embodiment of a user interface screen 1800 that includes a menu 1801 for selecting a method for using contents selected by the user from the search result. According to this embodiment, if the user selects a live streaming menu list 1802, it can use data downloaded in the display device through the network, in real-time. If the user selects a downloading menu list 1803, the user can download the selected content and store the downloaded content in the display device.

Through the aforementioned user interface, the user can conveniently use the method for using the selected content.

One or more of the aforementioned embodiments, therefore, are directed to a method for synchronizing contents and a display device enabling the method, which substantially obviate ones or more problems due to limitations and disadvantages of the related art.

One or more of these embodiments provide a method for synchronizing contents data of a plurality of display devices more easily and conveniently to use various contents stored in various display devices and a contents synchronizing system and display device enabling the method.

One of more of these embodiments also provide a method for synchronizing contents to easily identify and store the synchronized contents, and a display device enabling the method.

One or more other embodiments provide a method for synchronizing contents to quickly and conveniently search for contents stored in a separate display device and easily use the searched contents, and a display device enabling the method.

To achieve these objects and other advantages, a method for synchronizing contents in accordance with one embodiment comprises selecting first contents for synchronization in a first display device; selecting a second display device for synchronizing the selected first contents; transmitting a list of the selected first contents from the first display device to a predetermined server; comparing a list of second contents of the second display device, which are stored in the server, with the list of the first contents; transmitting contents of the first contents, which are not included in the list of the second contents, from the first display device to the server in accordance with the compared result; and transmitting the transmitted contents from the server to the second display device.

In another embodiment, a method for synchronizing contents comprises, if contents for synchronization are received in a predetermined display device from a predetermined server, displaying a list of the received contents to a display module of the display device; and, if a synchronization confirmation command for the received contents is input, updating a list of contents stored in the display device.

In another embodiment, a method for synchronizing contents comprises selecting a content keyword and a second display device for searching contents from a user interface output from a first display device; transmitting the content keyword and information on the second display device to a predetermined server; receiving a search result of contents corresponding to the content keyword among contents stored to correspond to the second display device, from the server; and displaying the search result to a display module of the first display device, selecting contents included in the search result, and receiving the selected contents from the server.

In another embodiment, a contents synchronization system through a network comprises a predetermined server storing and comparing lists of contents stored in a display device connected thereto through a network; a first display device selecting contents for synchronization, transmitting a list of the selected contents to the server, and transmitting the contents to the server in accordance with the compared result; and a second display device receiving the contents for synchronization.

In another embodiment, a display device for synchronizing contents through a network comprises a network interface module for receiving contents for synchronization from a predetermined server; a memory module for storing the received contents and a list of contents stored in the display device; a display module for displaying a list of the received contents; a user input interface module for receiving a synchronization confirmation command for the received contents; and a control module displaying the list of the received contents through the display module if the contents for synchronization are received through the network interface module, and updating the list of contents if the synchronization confirmation command for the received contents is received.

In another embodiment, a display device for searching contents through a network comprises a network interface module for transmitting and receiving data to and from a predetermined server connected thereto through a network; a memory module for storing contents data and a list of contents for memory; a user input interface module for receiving a selection signal for a content keyword and a display device for search; and a control module transmitting the selection signal to the server through the network interface module if the selection signal for the content keyword and the display device for search is received through the user input interface module, and receiving the search result from the server through the network interface module.

In accordance with another embodiment, a synchronizing method comprising: selecting first content in a first display device; selecting a second display device to be synchronized; sending a list of the first content from the first display device to a server; comparing a list of second content of the second display device with the list of first content; transmitting the first content from the first display device to the server when the first content is not included in the list of second content; and transmitting the first content from the server to the second display device.

The list of second content may be stored in the server, and the first content includes one or more files, the files selected from the group consisting of a video data file, an audio data file, an image data file, and a text data file.

The step of selecting the second display device includes: displaying, on the first display device, a list of display devices coupled to the server, and selecting at least one of the display devices from the list. The step of selecting the first content includes: displaying a window for receiving one or more search terms; searching the first display device for the one or more search terms; and outputting results of the search with display of the window.

In addition, the method includes displaying a list of one or more additional display devices including the second display device, wherein the second display device is selected from the list. The list of one or more additional display devices is displayed with the window and the result of the search on a same screen. Additional information corresponding to the selected first content may also be displayed on the first screen.

The step of selecting the first content includes: displaying a list of items; and receiving one or more signals selecting a corresponding number of items in the list. In addition, the method may include automatically transcoding the first content into a format compatible for display on the second display device before the first content is transmitted to the server.

In accordance with another embodiment, a synchronizing method comprises receiving content in a first display device, displaying a list of the received content on the first display device; receiving a confirmation signal to synchronize the received content in the first display device; and updating a list of content in the first display device based on the received content, wherein the content is stored on a second display device coupled to the first display device through a server and wherein the received content corresponds to at least one of an image file, a video file, an audio file, or a text file.

The method may also include displaying numeric information indicating how many items are included in the received content available for synchronization on the first display device. Also the confirmation signal may indicate that fewer than all of the items identified by the numeric information are to be synchronized in the first display device. In addition, the method may further include displaying a notification message for the received content.

In accordance with another embodiment, a multifunctional display device, comprises a tuner configured to tune to a channel of a broadcast signal; a network interface configured to receive data packets; a display module; a wireless input interface configure to receive signals from a wireless remote control device; a storage device to store data, the data including content and a first list indicative of the content stored in the storage device; and a processor to control the display module based on at least one of broadcast signal, data packets or signals received from the wireless remote control device.

The processor may be configured to execute an instruction to send a request to update the content; an instruction to receive packet data containing additional content; an instruction to store the additional content; and an instruction to update the first list to reflect the additional content.

The instruction to send a request to update the content is executed based on a selection of an icon indicating a number of content items to be updated, the icon displayed on the display module, the icon is displayed simultaneously with other content being displayed on the display module, and the display module may display images or highlighted information corresponding to additional content stored in the storage device.

Additionally, information may be displayed to indicate a type of the received content, wherein the instruction to send the request to update the content is executed after said information indicating a type of the received content is displayed. Also, the processor may execute an instruction to transmit the updated first list to a server.

In accordance with one or more of the foregoing embodiments, when the user synchronizes contents stored in different display devices, the contents can be selected and synchronized easily and conveniently. Also, types and the number of the synchronized contents may be checked and conveniently determined whether to store the synchronized contents. Also, the user can quickly and conveniently search for contents stored in a separate display device and can easily use the searched contents.

The suffixes ‘module’ and ‘unit’ for the elements used in the following description are given or used in common by considering facilitation in writing this disclosure only but fail to have meanings or roles discriminated from each other.

In the meantime, a display device as described in this specification may be, for example, an intelligent display device additionally provided with a computer support function in addition to a broadcasting receiving function. The display device can be provided with a more convenient interface such as a manual input unit, a touch screen and a spatial remote controller, in accordance with additional Internet function in addition to a basic broadcasting receiving function.

Also, the display device enables e-mailing, web browsing, banking or games by accessing Internet or computer in accordance with the support of wire or wireless Internet function. For these various functions, a standardized general-purpose operating system (OS) can be used.

Accordingly, since the display device disclosed herein can freely be provided with or delete various applications on a general-purpose OS kernel, it may perform user-friendly various functions. More detailed examples of the display device include network TV, HBBTV, smart TV. The display device may be applied to a smart phone as the case may be.

Also, the term, “content” or “contents” disclosed herein may refer to any type of digital information capable of being provided through various wire and/or wireless communication networks for use, presentation, processing, and/or displayed in a display device.

In the meantime, the operation method for the display device according to one or more embodiments described herein can be implemented in a recording medium, which can be read by a processor provided in the display device, as a code that can be read by the processor. The recording medium read by the processor includes all kinds of recording media in which data that can be read by the processor are stored.

Examples of the recording medium include ROM, RAM, CD-ROM, magnetic tape, floppy disk, and optical data memory. Also, another example of the recording medium may be implemented in a type of carrier wave such as transmission through Internet. Also, the recording medium that can be read by the processor may be distributed in a computer system connected thereto through the network, whereby codes that can be read by the processor can be stored and implemented in a distributive mode.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A synchronizing method comprising:
selecting first content in a first display device;
selecting a second display device to be synchronized;
sending a list of the first content from the first display device to a server;
comparing a list of second content of the second display device with the list of first content;
transmitting the first content from the first display device to the server when the first content is not included in the list of second content; and
transmitting the first content from the server to the second display device.

2. The method of claim 1, wherein the list of second content is stored in the server.

3. The method of claim 1, wherein the first content includes one or more files, the files selected from the group consisting of a video data file, an audio data file, an image data file, and a text data file.

4. The method of claim 1, wherein selecting the second display device includes: displaying, on the first display device, a list of display devices coupled to the server, and selecting at least one of the display devices from the list.

5. The method of claim 1, wherein selecting the first content includes:
displaying a window for receiving one or more search terms;
searching the first display device for the one or more search terms; and
outputting results of the search with display of the window.

6. The method of claim 5, further comprising:
displaying a list of one or more additional display devices including the second display device, wherein the second display device is selected from the list.

7. The method of claim 6, wherein the list of one or more additional display devices is displayed with the window and the result of the search on a same screen.

8. The method of claim 7, further comprising:
displaying on the same screen additional information corresponding to the selected first content.

9. The method of claim 1, wherein selecting the first content includes:
displaying a list of items; and
receiving one or more signals selecting a corresponding number of items in the list.

10. The method of claim 1, further comprising:
automatically transcoding the first content into a format compatible for display on the second display device before the first content is transmitted to the server.

11. A synchronizing method comprising:
receiving content in a first display device,
displaying a list of the received content on the first display device;
receiving a confirmation signal to synchronize the received content in the first display device; and
updating a list of content in the first display device based on the received content, wherein the content is stored on a second display device coupled to the first display device through a server and wherein the received content corresponds to at least one of an image file, a video file, an audio file, or a text file.

12. The method of claim 11, further comprising:
displaying numeric information indicating how many items are included in the received content available for synchronization on the first display device.

13. The method of claim 12, wherein the confirmation signal indicates that fewer than all of the items identified by the numeric information are to be synchronized in the first display device.

14. The method of claim 11, further comprising:
displaying a notification message for the received content.

15. A multifunctional display device, comprising:
a tuner configured to tune to a channel of a broadcast signal;
a network interface configured to receive data packets;
a display module;
a wireless input interface configure to receive signals from a wireless remote control device;
a storage device to store data, the data including content and a first list indicative of the content stored in the storage device; and
a processor to control the display module based on at least one of broadcast signal, data packets or signals received from the wireless remote control device, wherein the processor is configured to execute the following:
an instruction to send a request to update the content;
an instruction to receive packet data containing additional content;
an instruction to store the additional content; and
an instruction to update the first list to reflect the additional content.

16. The device of claim 15, wherein an instruction to send a request to update the content is executed based on a selection of an icon indicating a number of content items to be updated, the icon displayed on the display module.

17. The device of claim 16, wherein the icon is displayed simultaneously with other content being displayed on the display module.

18. The device of claim 15, wherein the display module displays images or highlighted information corresponding to additional content stored in the storage device.

19. The device of claim 15, further comprising:
displaying information indicating a type of the received content,
wherein the instruction to send the request to update the content is executed after said information indicating a type of the received content is displayed.

20. The device of claim 15, wherein the processor executes:
an instruction to transmit the updated first list to a server.
